(19) United States
(12) Patent Application Publication
(10) Pub. No.: US 2026/0343300 A1
(43) Pub. Date: Oct. 29, 2026

(54) METHOD FOR L1/L2 TRIGGERED MOBILITY

(71) Applicant: ZTE Corporation, Shenzhen (CN)

(72) Inventors: Mengjie ZHANG, Shenzhen (CN); He HUANG, Shenzhen (CN); Jing LIU, Shenzhen (CN); Fei DONG, Shenzhen (CN)

(21) Appl. No.: 19/715,927

(22) Filed: Jun. 22, 2026

Related U.S. Application Data
(63) Continuation of application No. PCT/CN2023/141243, filed on Dec. 22, 2023.

(51) Int. Cl. H04W 24/10; H04B 7/06; H04W 36/00

(52) U.S. Cl. CPC H04W 24/10; H04B 7/0626; H04W 36/0072

(57) ABSTRACT

This disclosure is directed generally to wireless communications and more specifically to an improved configuration and execution of Layer-1/Layer-2 Triggered Mobility (LTM) and/or conditional LTM (CLTM). Such LTM or CLTM may be performed between cells provided within a central unit (CU) of an access network node (intra-CU LTM or CLTM) or provided CUs of different access network nodes (inter-CU LTM or CLTM). An inter-CU LTM or CLTM procedure, in particular, involves coordination between the different CUs and/or between the CUS and distributed units (DUs) thereof with respect to LTM preparation, configuration, security updates, and/or execution.

### TECHNICAL FIELD

This disclosure is directed generally to wireless communications technologies and more specifically to an improved configuration and execution of Layer-1/Layer-2 Triggered Mobility (LTM) and conditional LTM.

### BACKGROUND

In a wireless network, a wireless terminal device in communication with a serving cell may need to switch cells during mobility. It is desirable for such cell switches to be performed with reduced mobility latency, data interruption time, communication overhead and/or energy consumption in various network architectures and topologies.

### SUMMARY

This disclosure is directed generally to wireless communications technologies and more specifically to an improved configuration and execution of Layer-1/Layer-2 Triggered Mobility (LTM) and conditional LTM (CLTM). Such LTM or CLTM may be performed between cells provided within a central unit (CU) of an access network node (intra-CU LTM or CLTM) or provided between CUs of different access network nodes (inter-CU LTM or CLTM). An inter-CU LTM or CLTM procedure, in particular, involves coordination between the different CUs and/or between the CUs and distributed units (DUs) thereof with respect to LTM preparation, configuration, security updates, and/or execution.

In some example implementations, a method performed by a wireless terminal device is disclosed. The method may include, receiving a conditional layer-1/layer-2 (L1/L2) Triggered Mobility (LTM) configuration from a serving cell of a wireless network, the conditional LTM configuration comprising one or more candidate cell configurations, and an LTM cell switching condition for each of one or more candidate cells; performing an evaluation of the LTM cell switching condition; and in response to the LTM cell switching condition being met for a target cell among the one or more candidate cells, initiating a conditional LTM cell switch to the target cell from the serving cell.

In the example implementations above, the LTM cell switching condition comprises at least one of: one or more event triggering conditions; or an indication to indicate whether a relationship between the one or more event triggering conditions is “AND” or “OR” for triggering the initiation of the conditional LTM cell switch.

In any one of the example implementations above, the event triggering condition comprises at least one of: a layer-1 (L1) measurement identifier for indicating an event-triggered L1 measurement configuration for the conditional LTM; an L1 measurement report configuration identifier for indicating an event-triggered L1 measurement report configuration for the conditional LTM; a layer-3 (L3) measurement identifier for indicating an event-triggered L3 measurement configuration; a threshold or offset value that the event triggering condition needs to be met in order to trigger the initiation of the conditional LTM cell switch; a time period during which the event triggering condition needs to be met in order to trigger the initiation of the conditional LTM cell switch; a number of times that the event triggering condition needs to be consecutively met in order to trigger the initiation of the conditional LTM cell switch; a number of beams or Reference Signals (RSs) for which the event triggering condition needs to be met in order to trigger the initiation of the conditional LTM cell switch; or an indication to indicate whether a combination of the time period and the number of times for which the event triggering condition needs to be met in order to trigger the initiation of the conditional LTM cell switch.

In any one of the example implementations above, the method may further include comprising receiving assistance information for the conditional LTM cell switch from the serving cell, the assistance information comprising at least one of: a first threshold for cell measurement of the serving cell to control when the wireless terminal device is to start the evaluation of the LTM cell switching condition; a second threshold for cell measurement of a candidate cell or neighboring cell to control when the wireless terminal device is to start the evaluation of the LTM cell switching condition; a third indication to indicate whether the wireless terminal device can initiate the LTM switch upon a Master Cell Group failure or Secondary Cell Group failure; or a fourth indication to indicate whether the wireless terminal device is to perform the evaluation of the LTM cell switching condition only for a candidate cell for which the wireless terminal device has a valid Time Advance (TA).

In any one of the example implementations above, each of the first threshold and the second threshold comprises at least one of: an L1 Reference Signal Receive Power (RSRP), Reference Signal Receive Quality (RSRQ), or Signal-to-Interference plus Noise Ratio (SINR) threshold based on Synchronization Signa/PBCH Block (SSB); an L1 RSRP or RSRQ or SINR threshold based on Channel State Information Reference Signal (CSI-RS); an L3 RSRP or RSRQ or SINR threshold based on SSB; or an L3 RSRP or RSRQ or SINR threshold based on CSI-RS.

In any one of the example implementations above, the method may further include receiving a conditional LTM evaluation activation or deactivation command from the serving cell, the conditional LTM evaluation activation or deactivation indication comprising at least one of: a fifth indication to indicate whether the conditional LTM evaluation is to be activated or deactivated; one or more candidate to be activated or deactivated; one or more candidate beams/Reference Signals (RSs) of the one of more candidate cells to be activated or deactivated; or one or more CSI resource configurations of the one or more candidate cells to be activated or deactivated.

In any one of the example implementations above, the conditional LTM evaluation activation or deactivation command is conveyed via a Media Access Control (MAC) Control Element (MAC CE) transmitted from the serving cell.

In any one of the example implementations above, the method may further include, upon receiving the conditional LTM evaluation activation or deactivation command, activating or deactivating evaluation of the LTM cell switching condition corresponding to indicated candidate cells.

In any one of the example implementations above, initiating the LTM switch to the target cell from the serving cell comprises performing an LTM cell access to the target cell in a Random-Access-based (RACH-based) manner or a RACH-less manner depending on an availability of a valid TA value associated with the target cell.

In any one of the example implementations above, the method may further include, prior to initiating the conditional LTM cell switch to the target cell, performing a Physical Downlink Control Channel (PDCCH) order triggered early RACH towards the target cell and receiving a TA value of the target cell, wherein the conditional LTM cell switch to the target cell from the serving cell comprises performing the LTM cell access in the RACH-less manner.

In any one of the example implementations above, the early RACH is triggered by the wireless terminal device receiving a Downlink Control Information (DCI) from the serving cell, the DCI comprising at least one of: a sixth indication to indicate whether a reception of TA value by the wireless terminal device is required or not; a seventh indication to indicate which of the serving cell or target cell the wireless terminal device needs to receive the TA value from; a time window to monitor/wait to receive the TA value by the wireless terminal device; or a time value for controlling how long a MAC entity considers an acquired TA value as remaining valid.

In any one of the example implementations above, the serving cell and the one or more candidate cells are divided into one or more cell sets, each of the one or more cell sets being associated with a unique TA cell set identifier.

In any one of the example implementations above, when the TA cell set identifier of the target cell is the same as that of the serving cell, the valid TA value associated with the target cell is indicated as being the same as TA value of the serving cell.

In any one of the example implementations above, the LTM cell access is performed in the RACH-less manner.

In any one of the example implementations above, when the wireless terminal device determines that the TA cell set identifiers of the target cell and the serving cell are not the same, the method further comprises determining whether the valid TA value associated with the target cell has been obtained via an PDCCH order triggered early RACH procedure or a UE-based TA measurement by the wireless terminal device.

In any one of the example implementations above, when it is determined that the valid TA value associated with the target cell has not been obtained via the PDCCH order triggered early RACH procedure or the UE-based TA measurement, the method comprises performing the LTM cell access in the RACH-based manner.

In any one of the example implementations above, the LTM cell access is performed in the RACH-less manner, and the method further comprises accessing the target cell via a configured grant of the LTM or a dynamic grant of the LTM (DG LTM).

In any one of the example implementations above, the method may further include at least one of: sending a notification message to the serving cell to inform that at least one of LTM cell switching conditions of one or more candidate cells has been met or the conditional LTM cell switching is to be initiated; or monitoring PDCCH on the target cell for dynamic scheduling for the DG LTM.

In any one of the example implementations above, the notification message comprises at least one of: an identify of the target cell; TCI-state/beam information associated with the target cell; one or more candidate cell identifiers that the associated LTM cell switching condition has been met; or TCI-state/beam information associated with the candidate cell whose LTM cell switching condition has been met.

In any one of the example implementations above, the conditional LTM configuration further comprises a threshold for an RS/beam associated with a configured grant or a TCI-state.

In any one of the example implementations above, the threshold comprises an SSB based L1-RSRP threshold or a CSI-RS based L1-RSRP threshold.

In any one of the example implementations above, when the wireless terminal device determines that at least one RS with RSRP corresponding to the configured grant or the TCI-state above the threshold, further comprising at least one of: selecting an RS with RSRP above the threshold amongst the RS(s) associated with the configured grant; indicating an index of the selected RS to a lower layer; considering the configured grant as valid; or considering the TCI-state as valid, activated or applied.

In any one of the example implementations above, when the wireless terminal device determines that no RS with RSRP corresponding to the configured grant or the TCI-state above the threshold, further comprising at least one of: considering the configured grant as invalid; considering the TCI-state as not valid, not activated, or not applied; monitoring PDCCH on the target cell for dynamic scheduling; or performing an LTM cell access to the target cell in the RACH-based manner.

In some other example implementations, a method performed by a source access network node in a wireless network is disclosed. The method may include transmitting a conditional layer-1/layer-2 (L1/L2) Triggered Mobility (LTM) configuration to a wireless terminal device via a serving cell of the source access network node, the conditional LTM configuration comprising one or more candidate cell configurations, and an LTM cell switching condition for each of one or more candidate cells, to cause the wireless terminal device to perform a conditional LTM cell switch to a target cell from the serving cell when the LTM cell switching condition is met for a target cell among the one or more candidate cells.

In the example implementations above, wherein the LTM cell switching condition comprises at least one of: one or more event triggering conditions; or an indication to indicate whether a relationship between the one or more event triggering conditions is “AND” or “OR” for triggering the initiation of the conditional LTM cell switch.

In any one of the example implementations above, the event triggering condition comprises at least one of: a layer-1 (L1) measurement identifier for indicating an event-triggered L1 measurement configuration for the conditional LTM; an L1 measurement report configuration identifier for indicating an event-triggered L1 measurement report configuration for the conditional LTM; a layer-3 (L3) measurement identifier for indicating an event-triggered L3 measurement configuration; a threshold or offset value that the event triggering condition needs to be met in order to trigger the initiation of the conditional LTM cell switch; a time period during which the event triggering condition needs to be met in order to trigger the initiation of the conditional LTM cell switch; a number of times that the event triggering condition needs to be consecutively met in order to trigger the initiation of the conditional LTM cell switch; a number of beams or Reference Signals (RSs) for which the event triggering condition needs to be met in order to trigger the initiation of the conditional LTM cell switch; or an indication to indicate whether a combination of the time period and the number of times for which the event triggering condition needs to be met in order to trigger the initiation of the conditional LTM cell switch.

In any one of the example implementations above, the method may further include transmitting assistance information for the conditional LTM cell switch to the wireless terminal device via the serving cell, the assistance information comprising at least one of: a first threshold for cell measurement of the serving cell to control when the wireless terminal device is to start the evaluation of the LTM cell switching condition; a second threshold for cell measurement of a candidate cell or neighboring cell to control when the wireless terminal device is to start the evaluation of the LTM cell switching condition; a third indication to indicate whether the wireless terminal device can initiate the LTM switch upon a Master Cell Group failure or Secondary Cell Group failure; or a fourth indication to indicate whether the wireless terminal device is to perform the evaluation of the LTM cell switching condition only for a candidate cell for which the wireless terminal device has a valid Time Advance (TA).

In any one of the example implementations above, each of the first threshold and the second threshold comprises at least one of: an L1 Reference Signal Receive Power (RSRP), Reference Signal Receive Quality (RSRQ), or Signal-to-Interference plus Noise Ratio (SINR) threshold based on Synchronization Signa/PBCH Block (SSB); an L1 RSRP or RSRQ or SINR threshold based on Channel State Information Reference Signal (CSI-RS); an L3 RSRP or RSRQ or SINR threshold based on SSB; or an L3 RSRP or RSRQ or SINR threshold based on CSI-RS.

In any one of the example implementations above, the method may further include transmitting a conditional LTM evaluation activation or deactivation command to the wireless terminal device via the serving cell for the wireless terminal device to activate or deactivate evaluation of the LTM cell switching conditions, the conditional LTM evaluation activation or deactivation indication comprising at least one of: a fifth indication to indicate whether the conditional LTM evaluation is to be activated or deactivated; one or more candidate to be activated or deactivated; one or more candidate beams/Reference Signals (RSs) of the one of more candidate cells to be activated or deactivated; or one or more CSI resource configurations of the one or more candidate cells to be activated or deactivated.

In any one of the example implementations above, the conditional LTM evaluation activation or deactivation command is conveyed via a Media Access Control (MAC) Control Element (MAC CE).

In any one of the example implementations above, the method may further include receiving an LTM cell switch request from the wireless terminal device for an LTM cell switch from the serving cell to the target cell, the LTM cell switch request being generated upon determining by the wireless terminal device that the LTM cell switching condition is met for the target cell.

In some other implementations, a wireless communications apparatus is disclosed. The wireless communication apparatus may include a processor and a memory, wherein the processor is configured to read code from the memory and implement any one of the methods above.

In yet some other implementations, a non-transitory computer readable medium is disclosed. The non-transitory computer readable medium may include computer instructions, when executed by a processor of a wireless communication device, may cause the wireless communication device to implement any one of the methods above.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations/terminals or User Equipments (UEs) and a wireless access network node in communication with one another via an over-the-air radio communication interface.

FIG. 3 shows an example radio access network (RAN) architecture.

FIG. 4 shows an example communication protocol stack in a wireless access network node or wireless terminal device including various network layers.

FIG. 5 illustrates an example LTM procedure.

FIG. 6 illustrates vertical and horizontal key update procedures.

FIG. 7 illustrates and example conditional LTM procedure.

FIGS. 8-10 illustrate an example procedure for inter-CU LTM.

FIGS. 11-12 illustrate an example procedure for inter-CU LTM including CU/DU interactions.

### DETAILED DESCRIPTION

The present disclosure will now be described in detail hereinafter with reference to the accompanied drawings, which form a part of the present disclosure, and which show, by way of illustration, specific examples of embodiments. The present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

### Wireless Network Overview

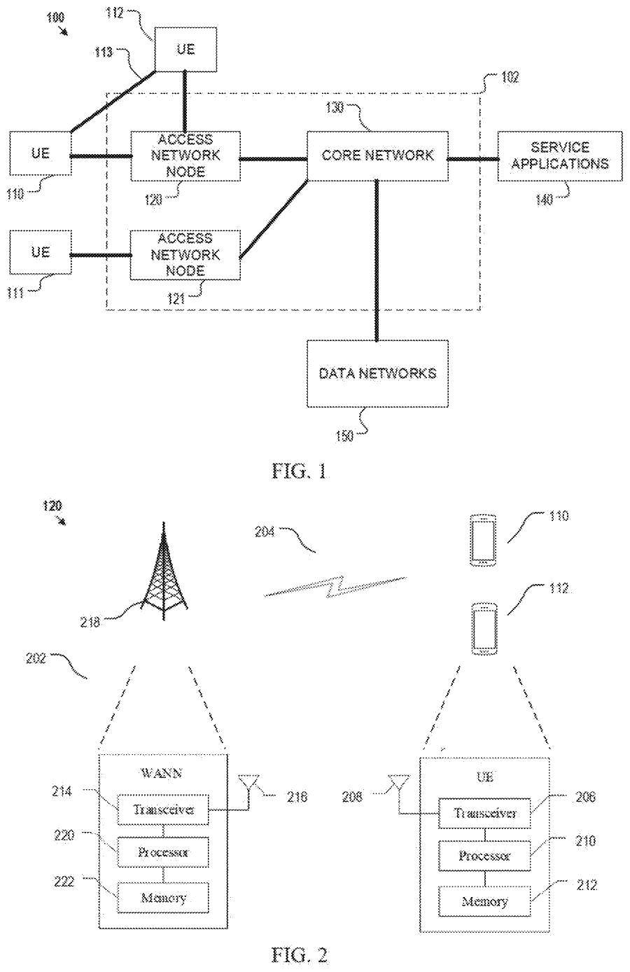

An example wireless communication network, shown as 100 in FIG. 1, may include wireless terminal devices or user equipment (UE) 110, 111, and 112, a carrier network 102, various service applications 140, and other data networks 150. The wireless terminal devices or UEs, may be alternatively referred to as wireless terminals. The carrier network 102, for example, may include access network nodes 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access network nodes 120 and 121 may be configured as various wireless access network nodes (WANNs, alternatively referred to as wireless base stations) to interact with the UEs on one side of a communication session and the core network 130 on the other. The term “access network” may be used more broadly to refer a combination of the wireless terminal devices 110, 111, and 112 and the access network nodes 120 and 121. A wireless access network may be alternatively referred to as Radio Access Network (RAN). The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the example wireless communication network of 100 of FIG. 1, the UEs may communicate with one another via the wireless access network. For example, UE 110 and 112 may be connected to and communicate via the same access network node 120. The UEs may communicate with one another via both the access networks and the core network. For example, UE 110 may be connected to the access network node 120 whereas UE 111 may be connected to the access network node 121, and as such, the UE 110 and UE 111 may communicate to one another via the access network nodes 120 and 121, and the core network 130. The UEs may further communicate with the service applications 140 and the data networks 150 via the core network 130. Further, the UEs may communicate to one another directly via side link communications, as shown by 113.

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a wireless base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station of a 5G gNB, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

The core network 130 of FIG. 1 may include various network nodes geographically distributed and interconnected to provide network coverage of a service region of the carrier network 102. These network nodes may be implemented as dedicated hardware network nodes. Alternatively, these network nodes may be virtualized and implemented as virtual machines or as software entities. These network nodes may each be configured with one or more types of network functions which collectively provide the provisioning and routing functionalities of the core network 130.

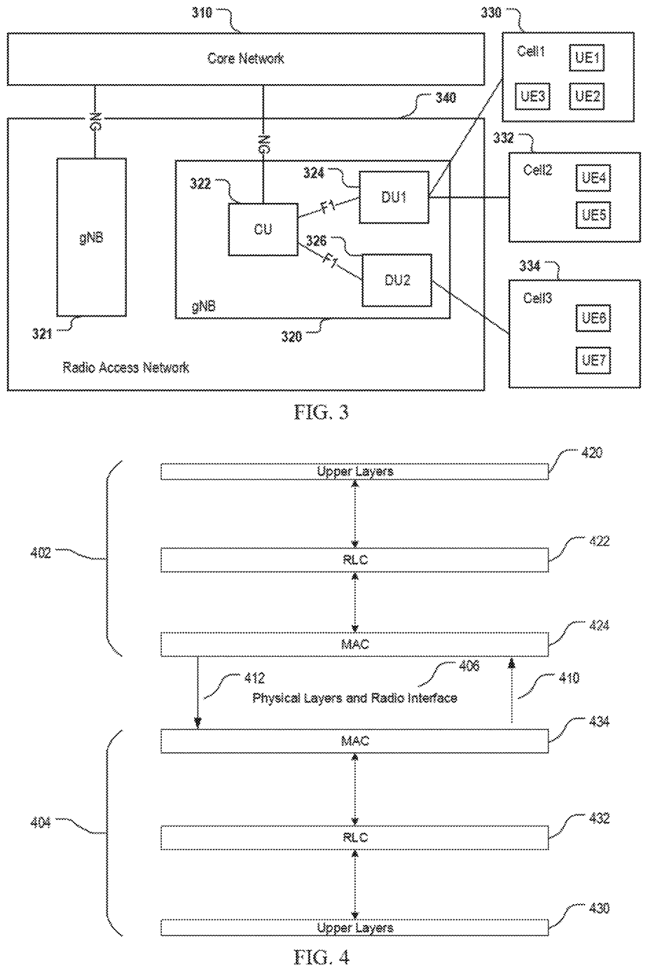

Returning to wireless radio access network (RAN), FIG. 3 illustrates an example RAN 340 in communication with a core network 310 and wireless terminals UE1 to UE7. The RAN 340 may include one or more various types of wireless base station or WANNs 320 and 321 which may include but are not limited to gNB, eNodeB, NodeB, or other type of base stations. The RAN 340 may be backhauled to the core network 310. The WANNs 320, for example, may further include multiple separate access network nodes in the form of a Central Unit (CU) 322 and one or more Distributed Unit (DU) 324 and 326. The CU 322 is connected with DU1 324 and DU2 326 via various interfaces, for example, an F1 interface. The F1 interface, for example, may further include an F1-C interface and an F1-U interface, which may be used to carry control plane information and user plane data, respectively. In some embodiments, the CU may be a gNB Central Unit (gNB-CU), and the DU may be a gNB Distributed Unit (gNB-DU). While the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

The UEs may be connected to the network via the WANNs 320 over an air interface. The UEs may be served by at least one cell. Each cell is associated with a coverage area. These cells may be alternatively referred to as serving cells. The coverage areas between cells may partially overlap. Each UE may be actively communicating with at least one cell while may be potentially connected or connectable to more than one cell. In the example of FIG. 1, UE1, UE2, and UE3 may be served by cell1 330 of the DU1, whereas UE4 and UE5 may be served by cell2 332 of the DU1, and UE6 and UE7 may be served by cell3 associated with DU2. In some implementations, a UE may be served simultaneously by two or more cells. Each of the UE may be mobile and the signal strength and quality from the various cells at the UE may depend on the UE location and mobility.

FIG. 4 further illustrates a simplified view of the various network layers involved in transmitting user-plane PDUs from a transmitting device 402 to a receiving device 404 in the example wireless access network of FIGS. 1-3. FIG. 4 is not intended to be inclusive of all essential device components or network layers for handling the transmission of the PDUs. FIG. 4 illustrates that the data packaged by upper network layers 420 at the transmitting device 402 may be transmitted to corresponding upper layer 430 (such as radio resource control or RRC layer) at the receiving device 304 via Packet Data Convergence Protocol layer (PDCP layer, not shown in FIG. 4) and radio link control (RLC) layer 422 and of the transmitting device, the physical (PHY) layers of the transmitting and receiving devices and the radio interface, as shown as 406, and the media access control (MAC) layer 434 and RLC layer 432 of the receiving device. Various network entities in each of these layers may be configured to handle the transmission and retransmission of the PDUs.

In FIG. 4, the upper layers 420 may be referred as layer-3 or L3, whereas the intermediate layers such as the RLC layer and/or the MAC layer and/or the PDCP layer (not shown in FIG. 4) may be collectively referred to as layer-2, or L2, and the term layer-1 is used to refer to layers such as the physical layer and the radio interface-associated layers. In some instances, the term “low layer” may be used to refer to a collection of L1 and L2, whereas the term “high layer” may be used to refer to layer-3. In some situations, the term “lower layer” may be used to refer to a layer among L1, L2, and L3 that are lower than a current reference layer. Control signaling may be initiated and triggered at each of L1 through L3 and within the various network layers therein. These signaling messages may be encapsulated and cascaded into lower layer packages and transmitted via allocated control or data over-the-air radio resources and interfaces. The term “layer” generally includes various corresponding entities thereof. For example, a MAC layer encompasses corresponding MAC entities that may be created. The layer-1 (L1), for example, encompasses PHY entities. The layer-2 (L2), for another example encompasses MAC layers/entities, RLC layers/entities, service data adaptation protocol (SDAP) layers and/or PDCP layers/entities.

### L1/L2 Triggered Mobility (LTM) in Intra-CU Cell Switching

LTM is a procedure in which a gNB (generally representing a base station) receives L1 measurement report(s) from a UE, and on that basis the gNB changes UE's serving cell by a cell switch command signaled via, for example, a MAC CE. The cell switch command indicates as a target cell an LTM candidate cell with a cell configuration that the gNB previously prepared and provided to the UE through RRC signaling. Then the UE switches to the target cell according to the cell switch command. The cell switch command may be conveyed in a MAC CE, which contains the necessary information to perform the LTM cell switch.

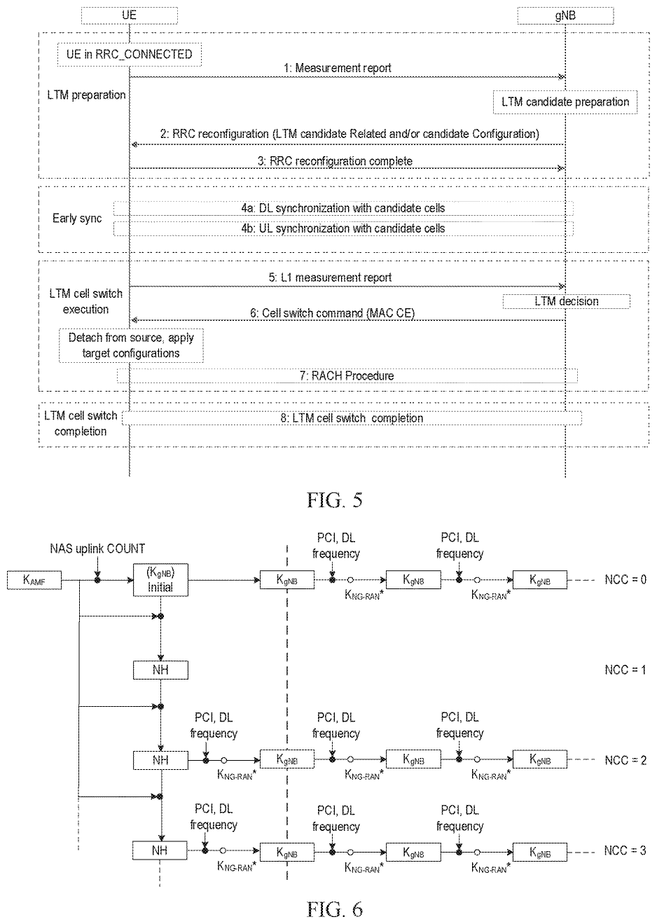

An overall example procedure for LTM is shown in FIG. 5. Subsequent LTM is done by repeating the early synchronization, LTM cell switch execution, and LTM cell switch completion steps without releasing other LTM candidate cell configurations after each LTM cell switch completion. FIG. 5 may be applied to a scenario that the cell switch is intra-CU, and as such only one gNB is shown and the LTM cell switch may occur between a source cell and a target cell associated with the same gNB. The example general procedure of FIG. 5 may be applicable to Main-Cell-Group (MCG) LTM cell switching and/or Secondary-Cell-Group SCG LTM cell switching.

The example general procedure of FIG. 5 for LTM is described as follows. The numeral headers represent the corresponding steps of FIG. 5.
1. The UE sends a MeasurementReport message to the gNB in the current communication connection with a source cell associated with the gNB. The gNB receives MeasurementReport message and then decides, based on the MeasurementReport message, to initiate LTM preparation to configure future LTM cell switch.
2. The gNB transmits an RRCReconfiguration message to the UE including the LTM candidate cell configurations for candidate cells.
3. The UE stores the LTM candidate cell configurations and transmits an RRCReconfigurationComplete message to the gNB. Steps 1-3 may be referred to as an LTM preparation procedure.
4a. The UE may perform downlink (DL) synchronization with the candidate cell(s) before receiving the cell switch command.
4b. If configured/indicated by the network, the UE may perform UE-based Time Advance (TA) measurement(s) or PDCCH order triggered early RACH to acquire the TA value(s) of one or multiple candidate cells before receiving the cell switch command. For UE-based Time Advance (TA) measurement(s), the UE performs TA measurement(s) for the candidate cells after being configured by RRC but the exact timing for the UE to perform the TA measurement(s) is up to UE implementation. For PDCCH order triggered early RACH, this may be done via Contention Free Random Access (CFRA) triggered by a Physical Downlink Control Channel (PDCCH) order from the source cell, following which the UE sends preamble towards the indicated candidate cell. Then the indicated candidate cell calculates the TA value(s). In order to minimize the data transmission interruption of the source cell in the current communication with the UE due to the CFRA towards the candidate cell(s), the candidate cell(s) may not transmit and the UE may not receive Random Access Response (RAR) for the purpose of TA value acquisition, and the TA value(s) of the candidate cell(s) may be indicated in the cell switch command to the UE. The UE may not maintain TA timer(s) for the candidate cell(s), and may rely on network implementation to guarantee TA validity instead. Steps 4a and 4b above may be referred to as an early synchronization procedure.
5. The UE performs L1 measurements on the configured candidate cell(s) and transmits L1 measurement reports to the gNB. L1 measurements should be performed as long as the RRC reconfiguration message (received in Step 2) is applied by the UE.
6. The gNB may decide to execute cell switch to a target cell (among the candidate cell(s)) and transmits, e.g., a MAC CE triggering the cell switch by including a candidate configuration index of the target cell (for identify the target cell configuration among one or more candidate cells). The UE may then switch to the target cell and applies the cell configuration indicated by the candidate configuration index.
7. The UE performs the random access procedure towards the target cell, if UE does not already have valid TA of the target cell from, for example, the synchronization procedure above. The random access procedure of Step 7 may be omitted if the UE has already obtained a valid TA of the target cell. Steps 5 through 7 above may be referred to as LTM cell switch execution procedure.
8. The UE completes the LTM cell switch procedure by sending RRCReconfigurationComplete message to the target cell. If the UE has performed a random access procedure in Step 7 above, the UE may consider that LTM cell switch execution is successfully completed when the random access procedure is successfully completed. For RACH-less LTM (where Step 7 is omitted), the UE may instead consider that LTM cell switch execution is successfully completed when the UE determines that the network has successfully received its first UL data.

The Steps 4-8 above can be performed multiple times for subsequent LTM using the LTM candidate configuration(s) provided in Step 2.

### Extended LTM

In some example implementations, the general procedure and the underlying principles of LTM in FIG. 5 may be extended to conditional LTM as described in further detail below. In addition, the LTM of FIG. 5 and the conditional LTM extended from FIG. 5 may be further applied or extended to scenarios beyond intra-CU. For example, such LTM and/or conditional LTM may be applied to inter-CU cell switching in addition to, for example, intra-CU inter-DU cell switching cases and intra-CU intra-DU cell switching cases.

As examples, such extended LTM or conditional LTM may be supported for at least one of the following scenarios:
LTM in Stand-Alone (SA) or Carrier Aggregation (CA);
MCG LTM in dual connect DC (e.g., NR-DC), e.g., including MCG LTM cell switching with SCG/SN release, MCG LTM cell switching with SCG/SN addition, MCG LTM cell switching without SCG/SN change, or MCG LTM cell switching with SCG/SN change;
SCG LTM in DC (e.g., NR-DC), e.g., including SCG LTM cell switching with MCG/MN change/involvement, or SCG LTM cell switching without MCG/MN change/involvement.

The general LTM implementations of FIG. 5 may be applied to all these different scenarios. The gNB of FIG. 5, in the inter-CU LTM situations, would correspondingly include both a source gNB and a target gNB (and/or other candidate gNBs). While the notation “gNB” is used in FIG. 5 and in the various example implementations described below, it may be considered as representing any type of base stations. Each of the such base stations, may include a CU and one or more DUs, as shown in FIG. 3.

The disclosure below applies to either or both of MCG LTM and SCG LTM unless specified otherwise. In the disclosure below involving MCG LTM, the term “candidate cell” is used to refer to MCG candidate cell (e.g., candidate PCell). For SCG LTM, the term “candidate cell’ is used to refer to SCG candidate cell (e.g., candidate PSCell).

### LTM Related Configuration

To adapt the LTM preparation procedure of FIG. 5 to be applicable to both intra and inter-CU LTM implementations, the RRC reconfiguration message in Step 2 may be provided by a current source gNB for the UE and it may contain an information element (IE) referred to as LTM related configuration (e.g., LTM_Config). Such LTM related configuration, as an IE of an RRC reconfiguration message, may include various fields specifying configurations related to LTM for the various candidate cells. For example, the LTM related configuration may include fields specifying configuration/parameter related to LTM and common for all candidate cell (associated with either the current source gNB for intra-CU LTM or another candidate gNB for inter-CU LTM). As one example of such common fields, the LTM related configuration may include one or a list of reference cell configuration(s). Each of these reference cell configurations may contain full or partial cell configuration/parameters common to a group of candidate cells, e.g., identified by a cell group ID. In some example implementations, each reference cell configuration may be included in the LTM related configuration message as an RRC container that link to another RRC reconfiguration message where the reference cell configuration information is included.

For another example, the LTM related configuration may include configuration/parameters specific to each of the candidate cells in the form of a list of configurations for candidate cells. The list of candidate cells can be added, removed, modified. Each of the list items may include cell-specific information items specifying LTM configuration/parameters specific to the corresponding candidate cell. Each of the list items may be referred to as LTM candidate configuration for a particular candidate cell. In some example implementations, one of the cell-specific information items of an LTM candidate configuration may indicate a candidate cell configuration. For example, such a cell configuration for a particular candidate cell may be implemented as an RRC container that links to another RRC reconfiguration message that includes cell configuration for the corresponding candidate cell (candidate cell configuration), which can either be a full/complete cell-configuration or delta cell configuration relative to a reference cell configuration described above. If delta cell-configuration is used, then the ID for the corresponding reference cell configuration may be specified as a field in the cell-specific information items for the corresponding candidate cell in the list described above.

In the disclosure below, the term “LTM related configuration” may be used to refer to all configurations for candidate cells that are related to LTM and that may be included in an RRC reconfiguration message, such as the RRC reconfiguration message transmitted in Step 2 of FIG. 5.

Further in this disclosure, the term “LTM candidate configuration” may be used to refer to a configuration associated with a candidate cell and that may be included in the LTM related configuration.

Further in this disclosure, the term “candidate cell configuration” may be used to refer to a configuration specific for a candidate cell and may be implemented as an RRC container including an RRC reconfiguration message. Such RRC reconfiguration message carrying the candidate cell configuration may include, for example, required parameters for cell switch, e.g., RadioBearerConfig, CellGroupConfig, MeasConfig, MasterKeyUpdate, and/or OtherConfig, etc., as described in further detail below. A candidate cell configuration, for example, can be a complete candidate configuration or a delta configuration relatively to a reference configuration.

Further in this disclosure, the term “reference configuration” may be used to refer to a cell configuration provided by the network to the UE that is common to a group of cells within a same cell group. A reference configuration may be a complete or non-complete candidate cell configuration. When the reference configuration is not complete, it may be combined with a delta configuration of the candidate cell for a derivation of a compete configuration for the candidate cell.

Further in the disclosure below, a “candidate cell configuration” or “reference configuration,” as described above and merely as an example, may be implemented as being conveyed by an RRC Reconfiguration message included into a container in the RRC Reconfiguration message carrying the LTM related configuration.

As one example, the LTM related configuration above, as provided from the serving cell of the network (e.g., from the source gNB) to the UE may include but is not limited to one or more of the following:
One or more reference cell configuration(s);
One or more LTM candidate configuration(s) (e.g., forming a list of configurations, each for one candidate cell);
Channel State Information (CSI) resource related configuration list/pool, e.g., for L1 measurement;
Serving cell no reset ID, e.g., ltm-ServingCellNoResetID, used by the UE to determine on whether L2 reset (e.g., PDCP data recovery, RLC re-establishment) should be performed when an LTM cell switch procedure is triggered towards an LTM candidate cell by comparing such serving cell no reset ID to a no reset ID associated with the candidate cell (whether they are the same or different), as will be described in further detail below;
Serving cell UE measured TA ID, e.g., ltm-ServingCellUE-MeasuredTA-ID, used by the UE to determine on whether UE-based TA measurements can be performed for a candidate cell by checking whether such serving cell UE measured TA ID is the same as or different from a UE measured TA ID associated with the candidate cell, as will be described in further detail below;
An indicator for LTM based recovery, e.g., to indicate whether LTM based recovery is allowed upon MCG Radio Link Failure (RLF) or mobility failure;
Serving cell security update ID, e.g., securityCellSetId, used by the UE to determine on whether security update should be performed when an LTM cell switch procedure is triggered towards an LTM candidate cell by comparing such serving cell security update ID to a security update ID associated with the candidate cell (whether they are the same or different), as will be described in further detail below;
One or more security related configuration(s).

In some example implementations, each LTM candidate configuration (provided per LTM candidate cell) within the LTM related configuration above may include but is not limited to at least one of the following information for a candidate cell:
LTM Candidate configuration ID;
Physical Cell ID (PCI) information of the candidate cell;
System Synchronization Block (SSB) related configuration, e.g., for L1 measurement or Transmission Configuration Indication State (TCI-state) configuration/information;
CSI-Reference Signal (CSI-RS) related configuration, e.g., for L1 measurement or TCI-state configuration/information;
Candidate cell configuration;
An indicator to indicate whether the candidate cell configuration is a complete configuration or not;
Early UL sync configuration;
TCI-state configuration/information, e.g., DL or joint TCI state list, UL TCI state list;
No reset ID for the candidate cell, e.g., ltm-NoResetID, used by the UE to determine on whether L2 reset (e.g., PDCP data recovery, RLC re-establishment) should be performed when an LTM cell switch procedure is triggered towards an LTM candidate cell by comparing such candidate cell no reset ID to a no reset ID associated with the current serving cell (whether they are the same or different);
UE measured TA ID, e.g., ltm-UE-MeasuredTA-ID, used by the UE to determine on whether UE-based TA measurements can be performed to acquire the TA of indicated candidate cell by checking whether such candidate cell UE measured TA ID is the same as or different from a UE measured TA ID associated with the current serving cell;
Security update ID, e.g., securityCellSetId, used by the UE to determine on whether security update should be performed when an LTM cell switch procedure is triggered towards an LTM candidate cell by comparing such candidate cell security update ID to a security update ID associated with the current serving cell (whether they are the same or different);
Reference configuration ID, used by the UE to identify a reference cell configuration. The reference configuration can be combined with the candidate cell configuration above (if partial) to derive a full/complete candidate cell configuration, as described in further detail below.

The reference configurations above are provided in order to reduce signaling overhead for candidate cell configuration (such that common cell configuration for multiple candidate cells can be signaled once and only delta cell configuration need to be included in each candidate cell configuration). For example, the NW can provide multiple reference configurations for the LTM candidate cell configurations, where, for example, each one of the reference configurations corresponds to one CU (or one candidate gNB).

In some example implementations as described above, the reference configuration(s), may include a list of reference configurations to add/modify (e.g., ltm-ReferenceToAddModList) and/or a list of reference configurations to release (e.g., ltm-ReferenceToReleaseList). In some example implementations, each configuration item in the list may be an RRC container for an RRC reconfiguration message that contains the reference configuration.

In some example implementations, each reference configuration is associated with a reference configuration ID.

In some implementations, as described above, a candidate cell configuration may be associated with a reference configuration ID, which, e.g., may be used by the UE to determine which reference can be used to generate the complete candidate configuration for the candidate cell alone or in conjunction with a cell configuration for the candidate cell. Specifically, for an LTM candidate cell which is a delta configuration (e.g., the corresponding LTM candidate configuration does not include a complete configuration indicator), the UE can apply its LTM candidate configuration on top of the reference configuration associated with the LTM candidate (e.g., by the reference configuration ID associated with the candidate cell configuration) to generate a complete cell configuration for the LTM candidate cell.

### Security Key Update

While security keys may not need updating for intra-CU LTM, they may need to be updated for inter-CU LTM, e.g., subsequent inter-CU LTM. As such, for a system where inter-CU LTM is implemented, the security key reuse and updating issues need to be considered. For key updates, a base station access key may be referred to as KgNB. For example, for subsequent inter-CU LTM, the security key reuse issue needs to be considered, e.g. the same KgNB is used while the UE is connected to gNB #1 before and after being connected to gNB #2, which may cause key stream reuse.

In some implementations, an example master cell key update information element, e.g., MasterKeyUpdate IE, may be used to update the KgNB, i.e., the Master Node key (MN key):

| MasterKeyUpdate ::= | SEQUENCE { | |
|---|---|---|
| keySetChangeIndicator | BOOLEAN, | |
| nextHopChainingCount | NextHopChainingCount, | |
| nas-Container | OCTET STRING OPTIONAL, | --Cond |

```
securityNASC
    ...
  }
```

The parameter keySetChangeIndicator above, for example, indicates whether the UE shall derive a new KgNB. If reconfigurationWithSync is included, value true for keySetChangeIndicator may indicate that a KgNB key is derived from an AMF key, e.g., KAMF, being utilized through the latest successful NAS SMC procedure, or N2 handover procedure with KAMF change, e.g., KgNB re-keying. Value false for keySetChangeIndicator indicates that the new KgNB key is obtained from the current KgNB key or from the Next Hop (NH). The parameter nextHopChainingCount represents a Next hop Chaining Counter (NCC). The parameter/field nas-Container is used to transfer UE specific NAS layer information between the network and the UE. The RRC layer is transparent for this field, although it affects activation of AS security after inter-system handover to NR.

FIG. 6 illustrates such an example KgNB generation and update procedure as a gNB is being accessed and re-accessed, through either a vertical key generation/updating process or a horizontal key generation/updating process described above.

In some example implementations suitable for supporting LTM cell switching, including inter-CU LTM cell switching, the following configuration for the UE may be used:
The core NW (e.g., AMF) may pre-configure a {NH (Next Hop), NCC (NH Chaining Counter)} pair for each candidate gNB. The NW may provide a security related configuration (e.g., MasterKeyUpdate IE, including an NCC value) per each candidate gNB or each cell set/group to the UE. In the security related configuration or through other configuration/signaling, the NW may also provide an indicator to indicate to the UE whether a horizontal key derivation or a vertical key derivation (or which derivation solution of option 1 and option 2 below) is allowed/used for security update operation upon LTM cell switching.
The UE may correspondingly store the received security related configuration (e.g., NCC values) for candidate gNBs or cell sets/groups into the UE variable.

For security update, e.g., upon LTM cell switch, at least one of the following options can be considered:
Option 1: the UE may use horizontal key derivation to derive a new KgNB when the UE switches back to the same gNB. For example, when the UE tries to access the previous gNB (e.g., switching back from other gNB), the UE may use previously derived KgNB for the same gNB as the input for new key derivation for the gNB.
Option 2: the UE may use the vertical key derivation to derive a new KgNB when the UE switches back to the same gNB. For example, when the UE access the candidate gNB for the first time, the UE may use the received NCC value for vertical key derivation to derive a new KgNB. The UE may then increase the NCC value stored at the UE by one each time after performing the vertical key derivation. When the UE tries to access the previous gNB (e.g., switching back from other gNB), the UE uses the stored NCC value for vertical key derivation to derive a new KgNB. Upon LTM execution, the UE may send the used NCC value (prior to the increment by 1) and/or the NCC value to be used for the next LTM execution (after increment by 1) to the NW by, e.g., including the NCC value into the RRCReconfigurationComplete message above (e.g., Step 8 of FIG. 5).

In some example implementations, the NW may be capable of dynamically updating/indicating the NCC value for the candidate gNB/cell/cell set via MAC CE, e.g., by including the NCC value in LTM cell switch command MAC CE (e.g., Step 6 of FIG. 5). If the UE receives such a new NCC value from the NW, the UE replaces the NCC value stored in the UE variable with the received one by the corresponding gNB/cell/cell set. The UE may then use the new or updated NCC value for key derivation with respect to the corresponding gNB/cell/cell set.

For example, when the target candidate gNB initiates a path switch procedure to a network node of the core NW (e.g., AMF), e.g., after the UE accesses this gNB, the core NW may send a newly computed {NH, NCC} pair to the target candidate gNB via, e.g., NGAP PATH SWITCH REQUEST ACKNOWLEDGE message, the candidate gNB may store the received new {NH, NCC} pair for further handovers. When or prior to a source gNB or a serving/source cell deciding to triggering LTM execution (e.g., indicating to the UE to switch to a candidate gNB/cell), the source gNB may interact with the candidate gNB via, e.g., an Xn message. If the candidate gNB has a newly received {NH, NCC} pair from the AMF, the candidate gNB may send the NCC to the source gNB. The source gNB would then indicate the received NCC to the UE, e.g., via a cell switch command MAC CE or other MAC CE. Upon receiving the new NCC value, the UE would replace the NCC value for the candidate gNB stored in the UE variable with the received one. The UE may then use the new NCC value for key derivation via, e.g., vertical key derivation procedure above, if the security key update is required upon LTM cell switch.

Configuration signaling for security from the NW may be included as part of the LTM related configuration described above or specifically within the above LTM candidate configuration of a particular candidate cell. For example, the LTM related configuration above may include at least one of the following:
Serving cell security update ID, e.g., referred to as securityCellSetId, which may be used by the UE to determine whether security update should be performed when an LTM cell switch procedure is triggered towards an LTM candidate cell from the serving cell;
Security related configuration which, for example, may include a list of security update configuration to add/modify (e.g., ltm-SecurityConfigToAddModList) and/or a list of security update configuration to release (e.g., ltm-SecurityConfigToReleaseList). Each security update configuration may include at least one of: a security update configuration ID, an NCC parameter/value (e.g., nextHopChainingCount), or a list of NCC parameter/value for a candidate cell; or
An indication to indicate whether the horizontal key derivation or the vertical key derivation (or which derivation solution of option 1 and option 2 below) is allowed/used for security update operation.

For another example, the LTM candidate configuration above for a particular candidate cell may include at least one of the following information for a candidate cell with respect to security update:
Security update ID for the candidate cell, e.g., securityCellSetId, used by the UE to determine whether security update should be performed when an LTM cell switch procedure is triggered towards the LTM candidate cell; or
An indication to indicate whether the horizontal key derivation or the vertical key derivation (or which derivation solution of option 1 and option 2 below) is allowed/used for security update operation.

As described above, the security key update may be required for inter-CU LTM, but may be not needed for intra-CU LTM. To facilitate security updates in implementations where both inter-CU and intra-CU LTM are allowed, the candidate cells configured for a UE may be indicated to the UE with respect to which candidate cells belong to the same gNB/CU/cell set, i.e., such that the UE can determine, when receiving an LTM switching command to switch from its current serving sell to a target cell, whether the key update is required by determining whether the current serving cell and the target cell belong to the same gNB/CU/cell set.

In some example implementations, the source/serving cell and/or candidate cells may be grouped into multiple cell sets. Each cell may be configured with a security cell set identifier (e.g., the securityCellSetId above) to identify which cell set it belongs to, such that:
if the LTM cell switch is executed between cells within the same cell set (e.g., the security update ID of the source cell is equal to that for the target cell), the security key update is not required;
whereas if the LTM cell switch is executed between cells belonging to different cell sets (e.g., the security update ID of the source cell is not equal to that for the target cell), the security key update is required.

In some example implementations as described above, the configured security cell set IDs, may be included in the LTM related configuration, for the serving cell (source cell), and in the LTM candidate configuration for each candidate cell within the LTM related configuration. The security cell set ID may refer to a security update configuration ID within the security related configuration as described above.

L2 Reset Signaling for Intra-CU and/or Inter-CU LTM

Intra-CU intra-DU LTM may not require L2 reset procedures such as Packet Data Convergence Protocol (PDCP) re-establishment and Radio Link Control (RLC) re-establishment. Instead, intra-CU inter-DU may at most require PDCP data recovery and RLC re-establishment. Inter-CU LTM, however, may require both PDCP re-establishment and RLC re-establishment upon cell switch.

In some example implementations, candidate cell may be grouped into cell sets. Each candidate cell may be identified by a cell set identifier such that cell switches between cells of different pairs of cell sets are associated with different L2 reset procedures.

Such grouping of candidate cell sets for L2-reset configuration purposes may be harmonized with the cell grouping with respect to security key updates described above when inter-CU LTM and intra-CU LTM are configured simultaneously. For example, considering that PDCP re-establishment is always required for security key update, the cell sets for L2-reset purposes may be combined with the cell sets for security key update purposes.

The cell grouping for L2-reset purposes may need to be further extended from the security key update cell grouping. For example, such extension may be implemented considering that an intra-CU cell switch may be either an intra-CU inter-DU cell switch or an intra-CU intra-DU cell switch, another level of candidate cell grouping may be introduced, thereby resulting in a two-level cell sets configuration. Such two-level cell sets may be pre-configured to indicate the L2 reset handling in different cases, e.g., for inter-CU, intra-CU inter-DU, and intra-CU intra-DU cases. Each cell set may be identified by a pre-configured cell set identifier. Each candidate cell for a UE may be configured with a cell set identifier to indicate which cell set the candidate cell belongs to, e.g., according to its associations with CUs and DUs of the candidate gNBs.

In one example implementation, the first-level cell set grouping of the two-level scheme above which harmonize the security update and L2-reset is to indicate whether the security key update and/or PDCP re-establishment is required for cell switch, whereas the second-level cell set grouping is to indicate, when PDSCP re-establishment and security key update is not required, whether the intra-CU LTM-like L2 reset handling (e.g., PDCP date recovery, RLC re-establishment) is required for cell switch. Specifically:
If LTM cell switch is executed between cells within the same first cell set (e.g., indicated by a first cell set ID, referred to as security update Set ID, being of the same value between the source cell and the target cell) and the same second cell set (e.g., indicated by a second cell set ID, referred to as no reset ID, being of the same value between the source cell and the target cell), the UE is not required to perform any of the security key update, PDCP re-establishment/PDCP data recovery, and RLC re-establishment upon LTM cell switch execution. The UE may need to perform MAC reset or partial MAC reset upon LTM cell switch execution.
If LTM cell switch is executed between cells within the same first cell set (e.g., indicated by the security update Set ID being of the same value between the source cell and the target cell) but belonging to different second cell sets (e.g., indicated by the no reset ID being of different values between the source cell and the target cell), the UE is not required to perform security key update and/or PDCP re-establishment, but needs to perform PDCP data recovery and/or RLC re-establishment upon LTM cell switch execution. The UE may need to perform MAC reset or partial MAC reset upon LTM cell switch execution.
If LTM cell switch is executed between cells belonging to different first cell set (e.g., indicated by the security update Set ID as being of different values between the source cell and the target cell), the UE needs to perform security key update, PDCP re-establishment and/or RLC re-establishment upon LTM cell switch execution. The UE may need to perform MAC reset or partial MAC reset upon LTM cell switch execution.

In the above implementations, values for the two cell set IDs, e.g., the security update set ID and the no reset ID may be configured for each of the serving cell and/or the candidate cells. Cells with the same ID value with respect to the security update set ID belongs to a same first level cell set, whereas cells with the same ID value with respect to the no reset ID belongs to a same second level cell set. If the security update ID of two cells are different, the UE may not need to check whether no reset ID of these two cells are the same or different. If the security update ID of two cells are the same, the UE may need to further check whether no reset ID of these two cells are the same or different in order to preform appropriate L2 reset handling.

In some example implementations, similar to the security update set ID, as described above, the no reset ID for the serving cell may be directly configured in the LTM related configuration above, whereas the no reset ID for candidate cells of a UE may be configured in LTM candidate configuration within the LTM related configuration.

### Enhancements on L1 Measurement

L1 measurement(s) are needed for the determination of cell switching in LTM. L1 measurement(s) tend to fluctuate greatly in a dynamic manner. In order to improve the L1 measurement robustness for LTM (e.g., to mitigate ping-pong issues that leads to frequent cell switches), reduce the frequent measurement/reporting and/or save the UE power consumption on L1 measurements, one or more of the following L1 measurement related schemes may be implemented:
Option 1: Event-triggered L1 measurement report may be introduced and implemented. For example, the NW may provide an L1 event-triggered measurement report configuration to the UE. The UE may trigger the L1 measurement report only when the L1 measurement results meet a configured event according to the L1 event-triggered measurement report configuration. As examples, a triggering event can be defined as one of the following:
   Ax-like events based on the L1 measurement result. For example, a triggering event can be an A3-like event where the L1 measurements of candidate/neighbor beam/RS or cell become better than the current serving beam or SpCell by a predefined or configured offset amount. For another example, a triggering event can be an A4-like event where the L1 measurements of candidate/neighbor beam/RS or cell become better than a predefined or configured threshold. For yet another example, the triggering event cay be an A5-like event where the L1 measurements of the current serving beam/RS or SpCell become worse than a first predefined or configured threshold (threshold 1) and the L1 measurements of candidate/neighbor beam/RS or cell become better than a second predefined or configured threshold (threshold 2);
   The L1 measurements of candidate beam/RS or neighbor/candidate cell meeting a threshold/event for consecutive N times, for N times within a specific/defined period, for consecutive N times within a specific/defined period, or for a specific/defined period (e.g., like Time-To-Trigger (TTT) timer); or
   A number of beams of the neighbor/candidate cell being better than a predefined or configured threshold is above a specific/predefined number.
Option 2: Filtering of L1 measurements may be introduced in order to remove fast measurement dynamics (e.g., measurement fluctuations).
Option 3: A new L1 measurement quantity may be introduced. For example, a cell-level measurement quantity based on L1 beam/RS measurements may be introduced.
Option 4: the UE may be configured to report additional/assistance information in the L1 measurement report to help NW reduce ping-pong effect in cell switch. For example, such additional/assistance information may include a number of times the L1 measurement result of a candidate beam or neighbor/candidate cell meets a threshold/event, a duration/time for which the L1 measurement result satisfies predefined or configured threshold/event, and/or candidate/neighbor cell or beam ID that has fulfill predefined or configured event/threshold, and/or the like.
Option 5: the UE may start L1 measurement according to L3 measurement result. For example, the UE may perform L1 measurement only if L3 measurement quality of the neighbor/candidate cell is higher than a predefined or configured threshold or if L3 measurement quality of the current serving cell is lower than a predefined or configured threshold.
Option 6: the NW may indicate to the UE whether to activate the L1 measurement and/or L1 measurement reporting via, e.g., a MAC CE.

In the disclosure, the term “L1 measurements” (e.g., as described above) may be used to refer to L1 measurement results. The L1 measurement results may include at least one of the following:
the L1 Reference Signal Receive Power (RSRP) or Reference Signal Receive Quality (RSRQ) or Signal-to-Interference plus Noise Ratio (SINR) based on SSB; or
the L1 RSRP or RSRQ or SINR based on CSI-RS.

In the disclosure, the term “beam/RS” (e.g., as described above) may be used to refer to at least one of SSB, CSI-RS or CSI resource.

In some example implementations, an L1 measurement activation/deactivation indication/command from the NW may be implemented via, e.g., a MAC CE. The L1 measurement activation/deactivation indication/command may include at least one of the following information items:
An indication/flag to indicate whether the L1 measurement and/or L1 measurement reporting is to be activated or deactivated;
One or more candidate cells (e.g., indicated by candidate cell ID, or candidate configuration ID) to be activated or deactivated;
One or more candidate beams/RSs of the candidate cell(s) (e.g., indicated by SSB index, or CSI-RS index) to be activated or deactivated; or
One or more CSI resource configurations of the candidate cell(s) (e.g., indicated by CSI resource configuration ID) to be activated or deactivated.

Upon reception of the indication/command (e.g., MAC CE) to activate the L1 evaluation/measurement, the UE shall active/start/perform the L1 measurement and/or L1 measurement reporting of the indicated candidate cell(s), beam(s)/RS(s), and/or CSI resource(s). Otherwise, if deactivation is indicated, the UE shall deactivate/stop/not perform the L1 measurement and/or L1 measurement reporting of the indicated candidate cell(s), beam(s)/RS(s), and/or CSI resource(s).

In some example implementations, the event-triggered L1 measurement report configuration (e.g., in Option 1 above) may include at least one of the following information:
The L1 report configuration ID;
The L1 resource configuration ID, e.g., for referring to the resource used for L1 measurement;
The L1 report resource configuration;
The threshold or offset value to be used for the triggering condition/event;
Time during which specific criteria for the threshold/event needs to be met in order to trigger a measurement report;
The number of times that the threshold/event needs to be met consecutively to trigger a measurement report;
The number of beams/RSs that the threshold/event needs to be met to trigger a measurement report;
An indication to indicate whether the combination of time and the number of times is required, e.g., N times within a specific/defined period that the threshold/event needs to be met to trigger a measurement report; or
An indication of whether or not the UE shall initiate the measurement reporting procedure when the leaving condition of the event is met for a beam/RS or cell which has triggered a measurement report previously. For example, if indicated, the UE shall initiate a measurement reporting when the L1 measurement results of the concerned beam/RS or cell does no longer met the event/threshold.

In the example implementations above, the L1 measurement ID may be configured to link one L1 measurement resource configuration (e.g., SSB configuration, CSI-RS configuration, CSI resource configuration) with one L1 measurement report configuration.

In some example implementations, the event-triggered L1 measurement report to the NW can be carried via an Uplink Control Information (UCI) message (e.g., as art of a CSI report) or via a UL MAC CE.

In some example implementations, an L1 measurement report may include at least one of the following information items:
The L1 report configuration ID;
The L1 measurement ID;
One or more candidate cell(s) (e.g., candidate cell ID, candidate cell configuration ID, frequency+PCI) that have met the event/threshold;
One or more candidate beam/RS(s) (e.g., candidate beam/RS ID) that have met the event/threshold;
The L1 measurement results;
The number of times the L1 measurement result of candidate beam or neighbor/candidate cell meets the threshold/event;
The duration/time for which the L1 measurement result satisfies the threshold/event; or
An indication/flag to indicate whether the reported measurements have met the additional condition, e.g., the configured number of times that the threshold/event needs to be met consecutively, the configured time window during which specific criteria for the threshold/event needs to be met.

In some example implementations, in order to reduce the frequent measurement/report and/or save the UE power consumption on L1 measurement(s), the NW may provide at least one of the following assistant information to the UE:
A threshold for the current serving cell (e.g. SpCell) measurement, e.g. to control when the UE is required to perform/start L1 measurement and/or L1 measurement reporting on candidate/neighbor cell or beam/RS. Upon/once the L1 or L3 measurement result of the current serving cell becomes worse or better than the corresponding threshold, the UE may perform at least one of the following example actions (1) start/perform the L1 measurement (e.g., SSB based L1 measurement, and/or CSI-RS based L1 measurement) for candidate/neighbor cell(s) or beam/RS(s); (2) start/perform the L1 measurement for event-triggered L1 measurement report for candidate/neighbor cell(s) or beam/RS(s); (3) activate/enable the event-triggered L1 measurement report for candidate/neighbor cell(s) or beam/RS(s).
A threshold for the candidate/neighbor cell measurement, e.g., to control when the UE is required to perform L1 measurement and/or L1 measurement reporting on this candidate/neighbor or beam/RS, and/or other candidate/neighbor cell(s) or beam/RS(s). The threshold can be configured per candidate cell or per beam/RS (e.g., SSB, CSI-RS). The UE may perform at least one of the following example actions: (1) upon/if the SSB based L1 measurement result of the candidate cell or beam/RS becomes better or worse than the corresponding threshold, the UE starts/activates/performs or stops/deactivates/not performs CSI-RS based L1 measurement of this candidate cell or beam/RS; (2) upon/if the CSI-RS based L1 measurement result of the candidate cell or beam/RS becomes better or worse than the corresponding threshold, the UE stops/deactivates/not performs or starts/activates/performs SSB based L1 measurement of this candidate cell or beam/RS; (3) upon/if the SSB based L1 measurement result of the candidate cell or beam/RS becomes better or worse than the corresponding threshold, the UE starts/activates/performs or stops/deactivates/not performs the L1 measurement (e.g., SSB based L1 measurement, and/or CSI-RS based L1 measurement) of other candidate cell(s) or beam/RS(s); (4) upon/if the CSI-RS based L1 measurement result of the candidate cell or beam/RS becomes better or worse than the corresponding threshold, the UE starts/activates/performs or stops/deactivates/not performs the L1 measurement (e.g., SSB based L1 measurement, and/or CSI-RS based L1 measurement) of other candidate cell(s) or beam/RS(s);

In some example implementations, the threshold or offset mentioned in the disclosure (e.g., as described above) may include at least one of the following:
the L1 RSRP or RSRQ or SINR threshold/offset based on SSB;
the L1 RSRP or RSRQ or SINR threshold/offset based on CSI-RS;
the L3 RSRP or RSRQ or SINR threshold/offset based on SSB;
the L3 RSRP or RSRQ or SINR threshold/offset based on CSI-RS.

### Conditional Mobility—General

Conditional mobility may be implemented in cell switching, where the UE determines to switch cells based on pre-configured condition(s) rather than cell switch command from the network. The conditional mobility can include both conditional LTM (CLTM) and conditional L3 mobility. In some example implementations, conditional mobility may be applied to LTM, i.e., CLTM. In some other example implementations, conditional L3 mobility can include, for example, at least one of Conditional Handover (CHO), conditional LTM, Conditional PSCell Addition (CPA), Conditional PSCell Change (CPC), subsequent Conditional PScell Addition/Change (CPAC), and the like. The disclosure below, while being described in the context of LTM, may be applicable to any one of the types for conditional mobility.

The term Conditional LTM (CLTM), in particular, may be used to refer to an LTM cell switch that is executed by the UE when one or more execution/triggering condition(s) are met. The UE may start evaluating the execution condition(s) upon receiving an CLTM configuration and stops evaluating the execution condition(s) upon/once a cell switch or a PCell/PSCell change is triggered, e.g., according to the CLTM configuration or cell switch/handover command from the NW.

The CLTM can be generally applicable to MCG cell switch and/or SCG cell switch. The LTM related configuration as described above can be applied to CLTM for the underlying LTM.

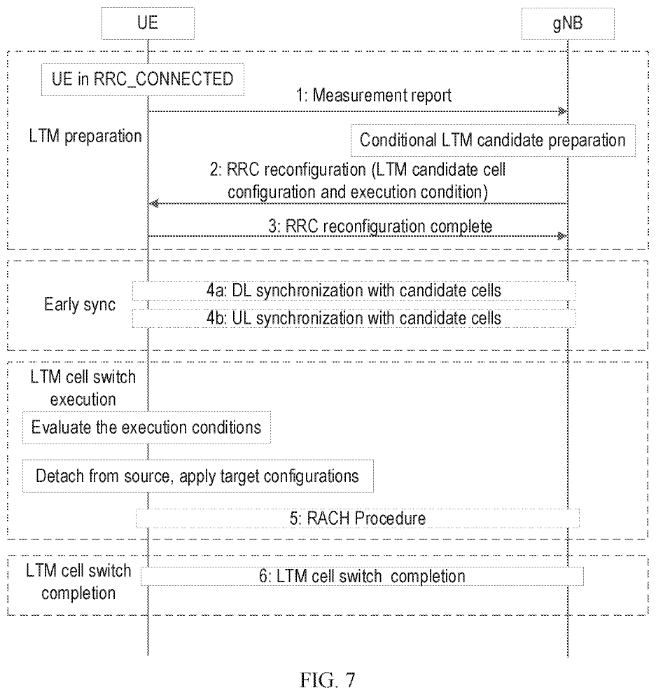

An example overall procedure of CLTM is shown in FIG. 7, applicable to both intra-CU and inter-CU CLTM. The gNB of the overall CLTM procedure of FIG. 7, in the inter-CU LTM situations, would correspondingly include both a source gNB and a target gNB. While the notation “gNB” is used in FIG. 7 and in the various example implementations described below for CLTM, it may be considered as representing any type of base stations. Each of such base stations, may include a CU and one or more DUs, as shown in FIG. 3. It may also represent a combination of a source gNB and a target gNB for inter-CU CLTM purposes. The example overall procedure of CLTM shown in FIG. 7 may include the following example steps (the numerical headers below correspond to the steps in FIG. 7):
1. The UE sends a MeasurementReport message to the gNB. The gNB decides to configure CLTM and initiates a CLTM preparation.
2. The gNB transmits an RRCReconfiguration message to the UE including a CLTM configuration, e.g., including one or more candidate configurations, and execution condition(s) for each candidate.
3. The UE stores the candidate configurations and transmits an RRCReconfigurationComplete message to the gNB.
4a. The UE may perform DL synchronization with the candidate cell(s).
4b. The UE may perform UL synchronization with the candidate cell(s), e.g., via UE-based TA measurement or PDCCH triggered early RACH.
5. The UE maintains connection with the source gNB after receiving the CLTM configuration, and starts evaluating the execution conditions for the CLTM candidate cell(s) as long as the RRC reconfiguration message (received in Step 2) is applied by the UE. If at least one CLTM candidate cell satisfies the corresponding execution condition(s), the UE selects a candidate cell to perform the LTM cell switch, e.g., by detaching from the source cell of the source gNB, and applies the stored corresponding candidate configuration for the selected candidate cell (i.e., target cell). If UE does not already have valid TA of the target cell, the UE performs a random access (RA) procedure towards the target cell. If the UE already has a valid TA of the target cell, the UE performs RACH-less cell switch to the target cell.
6. The UE completes the LTM cell switch procedure by sending RRCReconfigurationComplete message to target cell. If the UE has performed an RA procedure in step 5 above, the UE considers that LTM cell switch execution is successfully completed when the RA procedure is successfully completed. For RACH-less LTM, the UE considers that LTM cell switch execution is successfully completed when the UE determines that the network has successfully received its first UL data.

### Conditional Mobility—Execution Conditions

In Step 1 of FIG. 7 for CLMT, in addition to the LTM related configuration in comparison with the general LTM procedure of FIG. 5, the NW also provides an LTM cell switching condition or execution condition for each candidate cell. In some example implementations, the LTM cell switching condition or execution can include at least one of the following information:
One or more triggering conditions, or
An indication to indicate whether a relationship between multiple triggering conditions is “AND” or “OR” (if more than one triggering condition is provided), i.e., whether all or at least one of the multiple triggering conditions associated with a candidate cell needs to be met to trigger the CLTM execution. For example, if the relationship is “AND”, the UE shall trigger the CLTM execution upon all triggering conditions associated with a candidate cell are met, whereas if the relationship is “OR”, the UE shall trigger the CLTM execution upon any one of triggering conditions associated with a candidate cell is met.

The triggering condition for a candidate cell can include at least one of the following information items:
An L1 measurement ID, e.g., to identify an event-triggered L1 measurement configuration;
An L1 report configuration ID, e.g., to identify an event-triggered L1 measurement configuration;
An L3 measurement ID, e.g., to identify an event-triggered L3 measurement configuration;
An event-triggered L1 measurement configuration, e.g., including a threshold or offset value to be used/met for a triggering of CLTM;
Time during which specific criteria for a triggering event needs to be met in order to trigger the CLTM execution;
A number of times that the threshold/event needs to be met consecutively to trigger the CLTM execution;
A number of beams/RSs that the threshold/event needs to be met to trigger the CLTM execution;
An indication to indicate whether a combination of time duration and a number of times that the threshold/event is met is required in order to trigger the CLTM execution, e.g., N times within a specific/defined period that the threshold/event needs to be met to trigger the CLTM execution.

In some example implementations, the NW may provide at least one of the following assistant information items to the UE for the evaluation and/or execution of CLTM:
A threshold for the current serving cell (e.g. SpCell) measurement, e.g. to control when the UE is required to perform/start/active the CLTM evaluation on candidate/neighbor cell or beam/RS. Upon/once the L1 or L3 measurement result of the current serving cell becomes worse or better than the corresponding threshold, the UE may start/activate/perform or stop/deactivate/not perform the CLTM evaluation on candidate/neighbor cell or beam/RS;
A threshold for the candidate/neighbor cell measurement, e.g. to control when the UE is required to perform/start/active the CLTM evaluation on this candidate/neighbor or beam/RS, and/or other candidate/neighbor cell(s) or beam/RS. The threshold can be configured per candidate cell and/or per beam/RS (e.g. SSB, CSI-RS). The UE may perform at least one of the following example actions: (1) upon/if the SSB based L1 measurement result of the candidate cell or beam/RS becomes better or worse than the corresponding threshold, the UE starts/activates/performs or stops/deactivates/not perform the CLTM evaluation for CSI-RS based execution condition of this candidate cell; (2) upon/if the CSI-RS based L1 measurement result of the candidate cell or beam/RS becomes better or worse than the corresponding threshold, the UE stops/deactivates/not perform or starts/activates/performs the CLTM evaluation for SSB based execution condition of this candidate cell or beam/RS; (3) Upon/if the SSB based L1 measurement result of the candidate cell or beam/RS becomes better or worse than the corresponding threshold, the UE starts/activates/performs or stops/deactivates/not perform the CLTM evaluation for execution condition(s) of other candidate cell(s) or beam/RS(s); (4) Upon/if the CSI-RS based L1 measurement result of the candidate cell or beam/RS becomes better or worse than the corresponding threshold, the UE starts/activates/performs or stops/deactivates/not perform the CLTM evaluation for execution condition(s) of other candidate cell(s) or beam/RS(s);
An indication to indicate whether the UE can trigger the CLTM execution upon MCG or SCG failure, e.g., when Radio Link Failure (RLF) or Beam Failure Recovery (BFR) is detected on the source SpCell, or when mobility failure is detected. For example, if the indication is enabled, upon RLF or BFR, the UE shall select one of the candidate cells (e.g., if the candidate cell met a threshold configured by the NW) and trigger the CLTM execution; or
An indication to indicate whether the UE performs the CLTM evaluation only for the candidate cell who has the valid TA.

The threshold or offset referred to above can include at least one of the following:
the L1 RSRP or RSRQ or SINR threshold based on SSB;
the L1 RSRP or RSRQ or SINR threshold based on CSI-RS;
the L3 RSRP or RSRQ or SINR threshold based on SSB; or
the L3 RSRP or RSRQ or SINR threshold based on CSI-RS.

In some example implementations, in order to save the UE power consumption on the evaluation of CLTM conditions and improve the evaluation efficiency, the NW may activate/deactivate the evaluation of CLTM execution condition (e.g., via MAC CE), according to, e.g., various L1 or L3 measurements, or according to whether there is valid TA of the candidate cell, or according to whether there is activated TCI-state(s) of the candidate cell.

In some example implementations, the CLTM evaluation activation/deactivation indication/command above (e.g., via MAC CE) may include at least one of the following information items:
An indication/flag to indicate whether the CLTM evaluation is to be activated or deactivated;
One or more candidate cells (e.g., candidate cell ID, candidate configuration ID) to be activated or deactivated;
One or more candidate beams/RSs of the candidate cell(s) (e.g., SSB index, CSI-RS index) to be activated or deactivated; or
One or more CSI resource configurations of the candidate cell(s) (e.g., CSI resource configuration ID) to be activated or deactivated.

Upon reception of the CLTM evaluation activation/deactivation indication/command above, if it indicates activation of the CLTM condition evaluation, the UE may active/start/perform the evaluation of the indicated candidate cell(s), beam(s)/RS(s), and/or CSI resource(s). If deactivation of the evaluation is indicated instead, the UE shall deactivate/stop/not perform the evaluation of the indicated candidate cell(s), beam(s)/RS(s), and/or CSI resource(s).

Regarding which NW node with the source gNB to decide the execution condition for CLTM, two example options may be implemented:
Source CU: if the execution condition is based on L3 measurements;
Source DU: if the execution condition is based on L1 measurements.

### RACH-Less Mobility

The RACH-less mobility can include both LTM and L3 handover.

The RACH-less LTM and/or LTM cell switch described below can be generally applicable to the LTM cell switch triggered by the NW (e.g., via sending cell switch command) or the LTM cell switch triggered by the UE (e.g., the CLTM execution).

The method described below can also be generally applicable to the L3 handover triggered by the NW (e.g. via sending handover command in RRC signaling) or the L3 handover triggered by the UE (e.g. CHO, CPA, CPC). For L3 handover, the term “L1 measurement” may correspondingly be replaced with “L3 measurement”.

As shown in Step 5 of the general CLTM procedure of FIG. 7, upon triggering the CLTM execution (e.g., when the execution condition is satisfied/met), the UE may perform RACH-based LTM cell switch. Alternatively, the UE may perform a RACH-less LTM cell switch. Whether the UE is to perform a RACH-based or RACH-less LTM procedure may depend on an availability of a valid TA value for the target cell. If the UE has already obtained the valid TA of the target cell, the UE may perform the RACH-less LTM cell switch, an LTM cell switch procedure where UE skips the random access procedure with the target cell. If no valid TA value is available, the UE may perform the RACH-based LTM cell switch.

In some example implementations, the TA acquisition can be implemented in at least one of the following options:
Option 1: PDCCH order triggered early RACH with Random Access Response (RAR). For example, the source cell may send a signaling (e.g., DCI) to the UE to trigger an early RACH towards the candidate cell. The NW may include/indicate at least one of the following information via, e.g., the DCI: (1) an indicator to indicate whether a reception of RAR (or the TA value) by the UE is required or not; (2) an indicator to indicate which cell the UE needs to receive the RAR (or the TA value) from, e.g., the source cell or the candidate/target cell; (3) a time window to monitor/wait to receive the RAR (or the TA value) by the UE; (4) a time value which controls how long the MAC entity considers the acquired TA value is valid, e.g., referred to as timeAlignmentTimer value. The UE, in response to receiving the DCI, may send a RACH preamble to the indicated candidate cell. The candidate cell may then calculate the TA value according to, e.g., the received RACH preamble from the UE. If the RAR (or the TA value) is to be sent to the UE via the source cell, the candidate cell may send the TA value to the source cell first for the source cell to send the TA value to the UE. If the RAR (or the TA value) is to be sent to the UE via the candidate cell, the candidate cell sends TA value to the UE directly.
Option 2: UE-based TA measurement. For example, the UE may derive the TA value for the candidate cell based on Rx timing difference between current serving cell and the candidate cell as well as TA value for the current serving cell.
Option 3: Indication or configuration of TA value of the candidate cell by the NW. For example, the TA value of the candidate cell may be configured by the network as zero, or the TA value of the candidate cell may be configured as the same as the current serving cell (e.g., SpCell). In some example implementations, sets of cells can be configured to indicate which candidate or source cells have the same TA value. For example, an TA group/set ID is configured per candidate cell. Upon triggering the LTM cell switch, if the TA group/set ID of the source cell is equal to that for the target cell, the UE may consider the TA value of the target cell as being the same as the source cell, apply/keep the TA value of the source cell, and/or perform RACH-less cell switch. Otherwise, upon triggering the LTM cell switch, if the TA group/set ID of the source cell is not equal to that for the target cell, the UE may instead consider the TA value of the target cell not being the same as the source cell, and in such a situation, if the UE has a valid TA value of the target cell (e.g., as acquired by PDCCH order triggered early RACH or UE-based TA measurement), the UE may perform the RACH-less cell switch, and otherwise, the UE may perform the RACH-based cell switch.

For the RACH-less LTM, the UE may access the target cell (i.e., the selected candidate cell) using either a configured grant (CG) (referred to as CG based LTM) or a dynamic grant (DG) (referred to as DG based LTM).

In some example implementations, upon triggering the LTM cell switch, the UE may monitor PDCCH on the target cell for dynamic scheduling, e.g., for DG based LTM. The manner in which the NW may be informed about the selected candidate cell and/or the associated TCI-state/beam information of the selected candidate cell may be achieved via any one of the following example options:
Option 1: the UE may send a UL signaling (e.g., MAC CE or RRC message) to the source cell to inform the NW that at least one of the execution conditions of candidate cells has been met or the LTM execution is to be initiated. The UL signaling may include at least one of the following information: (1) the identity of the target cell (i.e., the candidate cell selected by the UE for CLTM execution), e.g., candidate cell configuration ID; (2) the selected TCI-state(s) (e.g., TCI-state ID) or beam/RS(s) (e.g., RS index) of the selected candidate cell; (3) one or more candidate cell identifiers that the associated execution condition has been met; or (4) the TCI-state(s) (e.g., TCI-state ID) or beam/RS(s) (e.g., RS index) of the candidate cell(s) that the associated execution condition has been met. In some other example implementations, upon reception of the UL signaling, the source node may inform the target candidate node about the selected candidate cell and/or the associated TCI-state/beam information, so that the target cell can start scheduling dynamic UL grant for the UE. The source node may also start the early data forwarding towards the selected candidate cell.
Option 2: the UE may transmit an SR or SRS to the target cell to inform the selected TCI-state/beam information of the target cell upon triggering the LTM cell switch. For example, the NW may configure the SRS configuration associated with TCI-state/beam(s) for each candidate cell. For another example, the UE may select the SRS occasion associated with a TCI-state/beam (e.g. the strongest one) to send the SRS to the target cell, to inform the selected TCI-state/beam information of the target cell.

In some other example implementations, upon triggering the LTM cell switch, if there is configured grant (which is associated with the beam/RS(s), e.g., SSB or CSI-RS) provided in the LTM candidate configuration of the target cell, e.g., for CG based LTM, the UE may select the configured grant occasion associated with the RS/beam to transmit the first UL signaling to the target cell based on, e.g., the L1 measurements on the RS/beam. For example, the UE may select an RS/beam (e.g., the strongest one) and consider the configured grant associated with this RS/beam as valid. Alternatively, the UE may select an RS/beam whose radio quality is above a threshold configured by the NW, and consider the configured grant associated with this RS/beam as valid.

In some example implementations, regarding the TCI-state/beam selection/decision of the target cell, the UE may select an RS/beam (e.g., the strongest one) and consider the TCI-state(s) associated with this RS/beam as valid/used/activated, e.g., for the data transmission with the target cell until a new TCI-state(s) is indicated by the target cell. Alternatively, the UE selects an RS/beam whose radio quality is above a threshold configured by the NW, and considers the TCI-state(s) associated with this RS/beam as valid/used/activated, e.g., for the data transmission with the target cell until a new TCI-state(s) is indicated by the target cell.

In some example implementations, the NW can configure a threshold for the RS/beam associated with the configured grant and/or a threshold for the RS/beam associated with the TCI-state(s). The threshold for configured grant and the TCI-state(s) may a same threshold or separate/different thresholds.

Example threshold can include at least one of an SSB based L1-RSRP threshold, or a CSI-RS based L1-RSRP threshold.

In some example implementations, if at least one RS (e.g., SSB or CSI-RS) with RSRP corresponding to the configured grant and/or the TCI-state(s) is above the configured threshold, the UE may perform at least one of the following:
select an RS with RSRP above the threshold amongst the RS(s) associated with the configured grant;
indicate the selected RS index to the lower layer;
consider the associated configured grant(s) as valid/activated/applied; or
consider the associated TCI-state(s) as valid/activated/applied.

In some example implementations, if there is no RS (e.g., SSB and/or CSI-RS) with RSRP corresponding to the configured grant and/or TCI-state(s) is above the configured threshold, the UE may perform at least one of the following:
consider the associated configured grant(s) as not valid/activated/applied;
consider the associated TCI-state(s) as not valid/activated/applied;
monitor PDCCH on the target cell for dynamic scheduling; or
initiate random access procedure, e.g. RACH-based LTM cell switch.

In some example implementations, if both SSB and CSI-RS are configured with the configured grant and/or TCI-state(s), and both are above the corresponding threshold, the UE may prioritize a selection of the CSI-RS associated with the configured grant and/or TCI-state(s).

In some example implementations, if at least one CSI-RS with RSRP corresponding to the configured grant and/or TCI-state(s) is above the configured threshold, the UE may perform at least one of the following:
select an CSI-RS with RSRP above the threshold amongst the CSI-RS(s) associated with the configured grant and/or TCI-state(s);
indicate the selected CSI-RS index to the lower layer;
consider the associated configured grant as valid/activated/applied; or
consider the associated TCI-state(s) as valid/activated/applied.

Otherwise, if at least one SSB with RSRP corresponding to the configured grant and/or TCI-state(s) is above the configured threshold, the UE may perform at least one of the following:
select an SSB with RSRP above the threshold amongst the SSB(s) associated with the configured grant and/or TCI-state(s);
indicate the selected SSB index to the lower layer;
consider the associated configured grant as valid/activated/applied; or
consider the associated TCI-state(s) as valid/activated/applied.

Otherwise, if there is no RS (e.g., SSB and/or CSI-RS) with RSRP corresponding to the configured grant and/or TCI-state(s) being above the configured threshold, the UE may perform at least one of the following:
consider the associated configured grant as not valid/activated/applied;
monitor PDCCH on the target cell for dynamic scheduling;
consider the associated TCI-state(s) as not valid/activated/applied; or
initiate random access procedure, e.g. RACH-based LTM cell switch.

### Inter-Node Interaction—General

The various additional disclosure below describes example inter-node interaction for the LTM and/or CLTM procedures above.

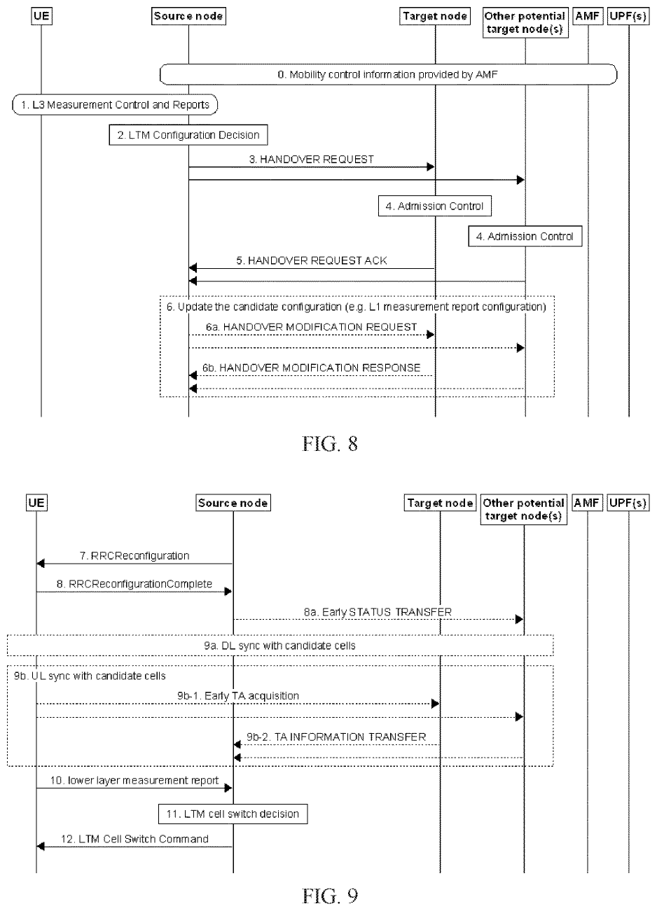

An example flow chart for inter-CU LTM is shown in FIGS. 8-10. The steps in the example flow in FIGS. 8-10 correspond to following description with like numerology headers:
0. Mobility control information is provided by AMF. For example, the UE context within the source node (e.g., source RAN node) may contain information regarding roaming and access restrictions which may be provided either at connection establishment or at the last TA update.
1. The UE sends a MeasurementReport message to the source node via, e.g., an L3 measurement control and report procedure.
2. The source node decides to configure LTM and initiates an LTM preparation procedure.
3. The source node sends a handover request message to each of one or more candidate nodes (target RAN nodes), referred to in FIGS. 8-10 as “target node” and “other potential target node(s)”. The message may include at least one of the following information:
   an indication to indicate that LTM or CLTM is requested;
   one or more requested/suggested candidate cell ID(s) (which may be determined by the source node according to information that the source node possesses);
   LTM candidate configuration ID(s) of the one or more candidate cell(s) with respect to the candidate node;
   LTM candidate configuration ID mapping list containing, e.g., a mapping between the candidate cell(s) and LTM candidate configuration ID;
   a request indication of L1 RS measurement configuration, which may further indicate whether an SSB configuration, a CSI-RS configuration or both are requested;
   a request indication of early TA acquisition resource configuration of the candidate cell(s) with respect to the candidate node;
   a request indication of TCI-state configuration of the candidate cell(s) with respect to the candidate node;
   a request indication of reference configuration;
   a reference configuration (e.g., if the source node has generated or acquired a reference configuration);
   a security update configuration, as described above; or
   a number representing the maximum number of candidate cells that the target candidate node can configure for LTM or CLTM.
1. Admission Control may be performed by the target node.
2. Each of the candidate nodes (target nodes) prepares the LTM related configuration and sends a handover request acknowledge message to the source node. The message may include one or more LTM candidate configuration(s), and may include CSI resource configuration (e.g., for L1 measurement) and/or security related configuration (e.g., for security key update). If the request indication of reference configuration is included in the handover request message, the candidate node may also include the generated reference configuration in the handover request acknowledge message. Each LTM candidate configuration for a candidate cell of the target node may include at least one of the following information:
   Candidate DU ID;
   Candidate cell ID;
   PCI information of candidate cell;
   SSB configuration, e.g., for L1 measurement or TCI-state configuration;
   CSI-RS configuration, e.g., for L1 measurement or TCI-state configuration;
   Candidate cell configuration, e.g., an RRCReconfiguration message included in a container;
   An indicator to indicate whether the candidate cell configuration is a complete configuration or not;
   Early UL sync configuration, e.g., early RACH configuration; or
   TCI-state configuration, e.g., DL or joint TCI state list, UL TCI state list.
1. The source node may initiate a modification procedure towards each of the candidate nodes (target nodes) to update the candidate cell configuration(s) (e.g., L1 measurement report configuration) and/or inform the candidate information in other candidate node(s). For example, e.g., in step 6a, the source node may send a modification message (e.g., handover request modification message or other Xn message) to the candidate or target node. The message may include the CSI resource configuration, the TCI-state information, the early UL sync configuration and/or LTM configuration IDs of candidate cells in other candidate or target nodes. The source node may also provide a reference configuration and/or security related configuration to the candidate node. In step 6b, the candidate node may respond with a modification request acknowledge message (e.g., handover request modification acknowledge message or other Xn message) to the source node. The message may include the updated candidate configuration(s) to the source node, e.g., the updated L1 measurement report configuration.
2. The source node transmits an RRC reconfiguration message to the UE including the LTM or CLTM configuration (e.g., including one or more LTM candidate configurations, and/or CLTM execution condition configuration).
3. The UE stores the LTM candidate configurations and transmits an RRCReconfigurationComplete message to the source node.
8a. If early data forwarding is applied, the source node may send the early status transfer message to candidate or target node(s), and/or start the data forwarding towards the candidate or target node(s). The early status transfer message may indicate the COUNT value (e.g., PDCP SN and/or HFN) of the first PDCP SDU that the source node forwards to the target node.
9a. The UE may perform DL synchronization with the candidate or target cell(s) before receiving the cell switch command.
9b. The UE may perform UL synchronization (e.g., UE-based TA measurement, PDCCH order triggered early RACH described above) with the candidate cell(s) before receiving the cell switch command, e.g., if indicated by the NW. For example, in step 9b, if the UL synchronization is triggered by a PDCCH order from the source cell, the UE sends a preamble towards the indicated candidate cell. The corresponding candidate or target node calculates the TA value of the candidate cell, e.g., based on the received preamble. The candidate node may send the TA value(s), the associated CFRA resource information(s), the candidate cell ID(s), the candidate DU ID(s) and/or the source DU ID to the source node via, e.g., TA information transfer message or other Xn message.
10. The UE performs L1 measurements on configured candidate cell(s) and transmits L1 measurement reports to the source node (e.g., source DU), according to the L1 measurement related configuration in the RRC reconfiguration message received in step 7. The UE may start to perform L1 measurement as long as the L1 measurement related configuration is applicable.
11. The source node decides to execute/trigger cell switch to a target cell, e.g., according to the L1 measurement results.
12. The source node transmits a cell switch command (e.g., cell switch MAC CE) to cell switch, e.g., by including the candidate configuration index of the target cell. The UE switches to the target cell and applies the configuration indicated by candidate configuration index.
13. The source node sends a notification message (e.g., cell switch notification message) to the target node to indicate the initiation/triggering of the LTM to the UE. The message includes the target cell ID and/or the selected TCI-state ID(s) of the target cell.
13a. If early data forwarding is applied, the source node sends an early status transfer message to the target node, and/or start the data forwarding towards the candidate or target node(s). In some example embodiments, the source node may send the early status transfer message to the candidate node, to inform the discarding of already forwarded PDCP SDUs, e.g., between step 8a and step 13a if early data forwarding has been started/performed.
14. The UE performs a random access procedure towards the target cell, if UE does not have valid TA of the target cell. If the UE has valid TA of the target cell, the UE skips random access procedure towards the target cell and instead perform RACH-less LTM.
15. The UE completes the LTM cell switch procedure by sending RRCReconfigurationComplete message to target cell. If the UE has performed a RA procedure in step 14, the UE considers that LTM cell switch execution is successfully completed when the random access procedure is successfully completed. For RACH-less LTM, the UE considers that LTM cell switch execution is successfully completed when the UE determines that the network has successfully received its first UL data.
16a/b. The target node may send a notification message (e.g., handover success message) to the source node to inform that the UE has successfully accessed the target cell. The message may include the target cell ID and/or the target DU ID. In return, the source node may send the SN status transfer message to the target node, and/or may start late data forwarding. The SN status transfer message may convey the uplink PDCP SN receiver status and/or the downlink PDCP SN transmitter status of DRBs for which PDCP status preservation applies (e.g. for RLC AM).
17. The target node sends a path switch request message to AMF to trigger core network to switch the DL data path towards the target node and to establish an interface (e.g., NG-C interface) instance towards the target node. The message may include an indicator to indicate whether the source node/cell is configured as a candidate node/cell for LTM/CLTM, or to indicate whether the DL data path (or the U-plane/TNL resources) towards the source node/cell is kept and/or switched to a prepared state.
18. The core network switches the DL data path towards the target node. If the source node/cell is not configured as a candidate node/cell, the core network (e.g., UPF) may send one or more “end marker” packets on the old path to the source node/cell per PDU session/tunnel and/or then may release any User-plane/TNL resources towards the source node/cell. If the source node/cell is configured as a candidate node/cell (e.g., for subsequent LTM/CLTM), the core network (e.g., UPF) may send one or more “end marker” packets on the old path to the source node per PDU session/tunnel, may keep the U-plane/TNL resources towards the source node/cell and/or may switch to the prepared state.
19. The AMF confirms the path switch request message with the path switch request acknowledge message. The path switch request acknowledge message may include one or more newly computed {NH, NCC} pairs for the target node. The target node shall store the received {NH, NCC} pair(s) for further handovers or cell switches.
20. If the source node/cell is not configured as a candidate node/cell, upon reception of the path switch request acknowledge message from the AMF, the target node may send a notification/release message (e.g., UE context release message or other message) to inform the source node/cell about the success of the LTM/CLTM, and/or to inform the source node/cell to release radio and Control-plane related resources associated to the UE context. If the source node/cell is configured as a candidate node/cell (e.g., for subsequent LTM/CLTM), upon reception of the path switch request acknowledge message from the AMF, the target node may send an notification/modification message (e.g., UE context modification message or other message) to inform the source node/cell about the success of the LTM/CLTM, to inform the source node/cell to keep radio and C-plane related resources associated to the UE context and/or to inform the source node/cell to switch to the prepared stated. Any ongoing data forwarding may continue.

In some other example implementations, not all steps in the flow chart needs to be performed. For example, the steps in the dotted line in the FIGS. 8-10 may be performed optionally. For another example, e.g., for CLTM procedure, the steps 10~12 may be ignored/skipped. Instead, the UE maintains connection with the source node/cell after receiving CLTM configuration, and starts evaluating the execution conditions for the candidate cell(s). If at least one candidate cell satisfies the corresponding execution condition, the UE selects a candidate cell to perform the LTM cell switch, e.g., detaching from the source cell, and applying the stored corresponding configuration for the selected candidate cell (i.e., target cell). If UE does not have valid TA of the target cell, the UE performs the random access procedure towards the target cell. If the UE has valid TA of the target cell, the UE performs RACH-less cell switch to the target cell.

In some other example implementations, the steps in the flow chart may not be performed in order.

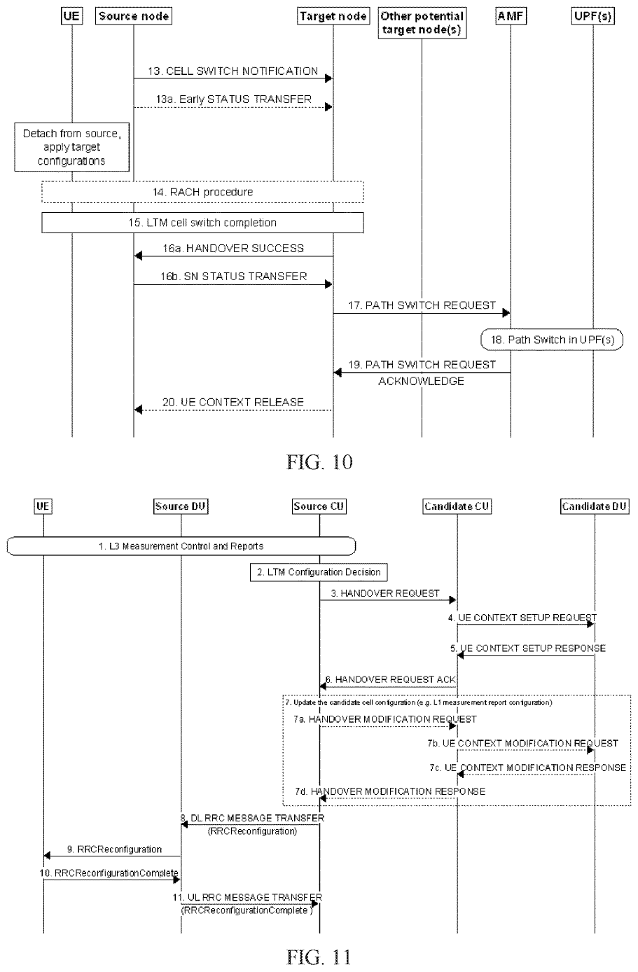

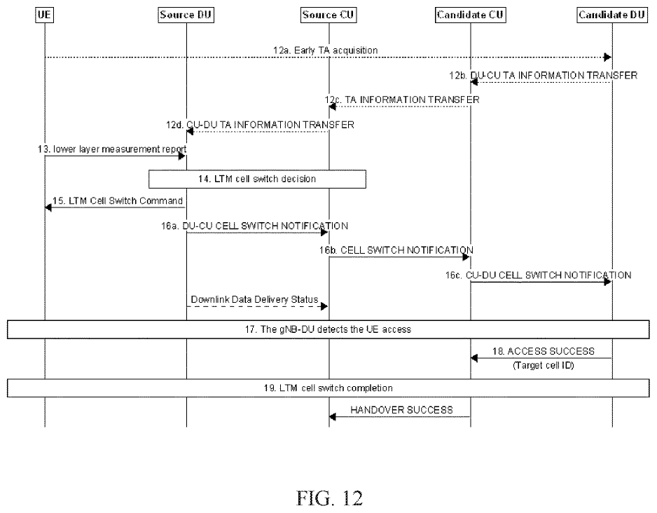

An example of the flow chart for inter-CU LTM (including the CU/DU split and interaction) is shown in FIGS. 11-12. The steps in the example flow in FIGS. 11-12 correspond to following description with like numerology headers:
1. The UE sends a MeasurementReport message to the source CU.
2. The source CU may then determine to initiate LTM/CLTM configuration/preparation.
3. The source CU sends a handover request message to the candidate CU, e.g., similar to Step 3 in FIG. 8.
4. The candidate CU sends a UE context setup request message to the candidate DU. The message may include the information as included in the handover request message as described above.
5. If the candidate DU accepts the request of LTM/CLTM configuration/preparation, it responds to its gNB-CU with a UE setup request response message including the generated lower layer RRC configuration (e.g., the CellGroupConfig, the L1 RS measurement configuration, the early TA acquisition resource configuration, and/or the TCI-state configuration) for the accepted candidate cell(s). The L1 RS measurement configuration, the early TA acquisition resource configuration, and/or the TCI-state configuration may be provided in separate IEs, e.g., outside of the container containing CellGroupConfig.
6. The candidate CU sends a handover request acknowledge message to the source CU, i.e., similar to the step 5 in FIG. 8.
7. The source node (source CU) may initiate a modification procedure towards each candidate node (candidate CU) to update the candidate cell configuration (e.g., L1 measurement report configuration) and/or inform the candidate information in other candidate node(s). For example:
   7a. This step is similar to Step 6a in FIG. 8.
   In Step 7b, the candidate CU sends a UE context modification request message to the candidate DU(s). The message may include the CSI resource configuration, TCI-state information, early UL sync configuration and/or LTM configuration IDs of candidate cells in other candidate nodes. The candidate CU may also provide a reference configuration to the candidate DU(s).
   In Step 7c, the candidate DU responses with a UE context modification request acknowledge message to the candidate CU. The message may include the updated candidate configuration(s) to the source node.
   7d. This step is similar to Step 6b in FIG. 8.
8. The source CU sends a DL RRC message transfer message to the source DU, which includes the generated RRCReconfiguration message with the LTM/CLTM configuration.
9. The source DU forwards the received RRCReconfiguration message to the UE.
10. The UE responds to the source DU with an RRCReconfigurationComplete message.
11. The source DU forwards the RRCReconfigurationComplete message to the source CU via an UL RRC message transfer message.
12a~d. If the UL synchronization is triggered by a PDCCH order from the source DU, the UE sends preamble towards the indicated candidate cell. The candidate DU calculates the TA value of the candidate cell, e.g., based on the received preamble. The candidate DU sends the TA value, the associated CFRA resource information, the candidate cell ID and/or the source DU ID to the candidate CU, e.g., via DU-CU TA information transfer message. And then the candidate CU transfers the received information to the source CU, e.g., via TA information transfer message, and the source CU transfers it to the source DU, e.g., via CU-DU TA information transfer message.
13. The UE sends the L1 measurement result to the source DU.
14. The source DU decides to trigger LTM execution to a candidate target cell. There may be several options that can be considered with respect to how to decide the LTM triggering:
   Option 1: the source DU may decide the triggering of LTM execution by itself, e.g., based on the received L1 measurements;
   Option 2: the source DU may coordinate with the source CU to decide the triggering of LTM execution. For example, the source DU may determine to trigger the LTM execution (e.g., based on L1 measurements) and send the information of the selected candidate target cell (e.g., target cell ID, and/or TCI-state/beam information of the target cell) to the source CU via F1 message. The source CU may accept or reject the selected cell and responds to the source DU via F1 message;
   Option 3: the source DU may coordinate with the target DU to decide the triggering of LTM execution. For example, the source DU may determine to trigger the LTM execution (e.g., based on L1 measurements) and send the information of the selected candidate target cell (e.g., target cell ID, and/or TCI-state/beam information of the target cell) to the source CU via a F1 message. The source CU may transfer the received information of the selected candidate target cell to the candidate target CU via a Xn message, e.g. handover modification request message. The target CU may notify the received information to the candidate DU via an F1 message. The target DU may accept or reject the selected target cell and respond to the target CU via F1 message. The message may include some additional information of the target cell, e.g., the activated BWP ID, the new {NH, NCC} value or NCC value described above.
   The target CU may respond to the source CU about the information of the target cell received from the target DU. The source CU may transfer the received information to the source DU, e.g., to generate the LTM cell switch command.
15. The source DU may send LTM cell switch command to the UE, i.e., similar to Step 12 in FIG. 9.
16a~c. The source DU may signal the source CU about the initiation of the LTM command to the UE, e.g., via DU-CU cell switch notification message. The message may include the target cell ID, and/or the selected TCI-state(s)/beam information of the target cell. The source CU may then transfer the received information to the target CU, e.g., via cell switch notification message. Then the target CU may forward the received information to the target DU, e.g., via CU-DU cell switch notification message.
17. The UE may perform a random access procedure towards the target cell, if UE does not have valid TA of the target cell. If the UE has valid TA of the target cell, the UE skips random access procedure towards the target cell, i.e., to perform RACH-less LTM instead. The target DU detects the UE access to the target cell.
18. The target DU sends an access success message to inform the target CU, e.g., including the target cell ID.
19. This step is similar to Step 15 in FIG. 10.
20. This step is similar to Step 16 in FIG. 10.

In some other example implementations, not all steps in the flow chart needs to be performed.

For example, the steps in the dotted line in the FIGS. 11-12 may be performed optionally. For another example, e.g., e.g., for CLTM procedure, the step 13~15 may be ignored/skipped. Instead, the UE maintains connection with the source node/cell after receiving CLTM configuration, and starts evaluating the execution conditions for the candidate cell(s). If at least one candidate cell satisfies the corresponding execution condition, the UE selects a candidate cell to trigger the execution of CLTM cell switch.

In some other example implementations, the steps in the flow chart may not be performed in order.

The indication/information referred to above can be transferred by one of the following options:
Option 1: The indication/information may be directly included in an Xn/X2 message or an F1 message, e.g., included as one information element.
Option 2: The indication/information may be included in an RRC message, e.g., CG-ConfigInfo, CG-Config, HandoverPreparationInformation message. The RRC message may be included as one information element in a Xn/X2 message or a F1 message.

### Inter-Node Interaction—Interaction on LTM Related IDs or Cell Sets

As described above, the NW may provide/configure some IDs per candidate cell or source/serving cell to indicate specific UE behaviors. Such IDs, for example, may include:
No reset ID, e.g., ltm-NoResetID, used by the UE to determine whether L2 reset (e.g., PDCP data recovery, RLC re-establishment) should be performed when an LTM cell switch procedure is triggered towards an LTM candidate cell, as described above;
UE measured TA ID, e.g., ltm-UE-MeasuredTA-ID, used by the UE to determine whether UE-based TA measurements can be performed to acquire the TA of the indicated candidate cell, as described above;
Security update ID, e.g., securityCellSetId, used by the UE to determine on whether security update should be performed when an LTM cell switch procedure is triggered towards an LTM candidate cell, as described above; or
TA group/set ID, used by the UE to determine whether the TA of the candidate cell is the same as the source cell; as described above.

In some example implementations, such LTM related IDs can be assigned/determined by the source node (e.g., source CU) or a candidate node (e.g., a candidate CU). For example, the No reset ID, UE measured TA ID and/or TA group/set ID may be assigned/determined by the candidate node. The security update ID may be assigned/determined by the source node.

In some example implementations, one of the following example procedures may be used to transfer LTM related ID(s) or cell set(s) between the source node and the candidate node:
The candidate node (e.g., candidate CU) may transmit at least one of the following information to the source node (e.g., source CU), e.g., via handover request acknowledge or other Xn message: (1) the mapping between the candidate cell (e.g., candidate cell ID, candidate cell configuration ID, PCI+frequency) and the LTM related ID(s), e.g., No reset ID, UE measured TA ID and/or TA group/set ID; (2) one or more candidate cells belong to the same cell set where cell switch between these cells is not required to perform the L2 reset; (3) one or more candidate cells belong to the same cell set where cell switch between these cells is not required to perform the security update; or (4) one or more candidate cells belong to the same cell set where UE based TA measurement can be performed;
The source node may decide/configure the LTM related ID(s) for the current serving cell and/or each candidate cell, e.g., according to the information from the candidate node;
The source node may transmit the mapping between the candidate cell (e.g., candidate cell configuration ID) and the LTM related ID(s) to the candidate node, e.g., via handover modification request message or other Xn message; or
The CU (e.g., source or candidate CU) may transmit the mapping between the candidate cell (e.g., candidate cell configuration ID) and the LTM related ID(s) to the DU (e.g., source or candidate DU), e.g., via UE context modification request message or other F1 message.

### Inter-Node Interaction—Data Forwarding

In the cell switch, no DL data can be transmitted by the target node/cell before the reception of forwarding data from the source node/cell, data forwarding delay (including data transmission delay over Xn/F1 interface and/or corresponding signaling delay for triggering data forwarding) may be even longer than cell switch or handover processing time over Uu interface. In order to reduce the mobility delay or data interruption time, early data forwarding can be considered.

In some example implementations, regarding when to start early data forwarding by the source node, several options can be considered:
Option 1: upon reception of RRCReconfigurationComplete message (for the confirmation of LTM configuration) from the UE, e.g., Step 8a in FIG. 8;
Option 2: upon sending the cell switch command MAC CE to the UE, e.g., Step 13a in FIG. 10; or
Option 3: upon the source DU decides to request/coordinate the triggering of LTM execution, e.g., if the source DU needs to coordinate with another NW node (e.g., the source CU, the target DU).

In some example implementations, the source node may send the early status transfer message, SN status transfer message and/or downlink data delivery status message to the candidate or target node, for the data forwarding. The early status transfer message is to transfer the COUNT of the first downlink SDU that the source node forwards to the target node or the COUNT for discarding of already forwarded downlink SDUs for respective DRB.

In some example implementations, the source node may send the early status transfer message to each of the one or more candidate nodes when reception of RRCReconfigurationComplete message (as described in option 1 above). The message may include the COUNT value (e.g. PDCP SN and/or HFN) of the first PDCP SDU that the source node forwards to the target node.

In some example implementations, the source node may send the early status transfer message to each of the one or more candidate nodes or the target node before or when sending the cell switch command to the UE. The message is to inform the candidate or target node to discard the already forwarded PDCP SDUs, if the early data forwarding has been started/performed.

In some example implementations, source node (e.g., source CU) may decide to start early data forwarding to some candidate cells and/or send Early Status Transfer message(s) to the candidate node/cell(s), e.g., for the candidate cells whose L1 measurement report has been received, the candidate cells whose one or more TCI-state(s) has been activated, and/or the candidate cells who has acquired the TA.

### Harmonization of Signaling Framework for Various Type of Mobilities

In some example implementations, common RRC container and RRC level procedure can be used for different types of mobilities, e.g., UE based triggering mobility, NW based triggering mobility. The UE based triggering mobility may include CHO, CPAC, subsequent CHO/CPAC, CLTM, and/or CLTM. The NW based triggering mobility may include L3 Handover, LTM, and/or subsequent LTM.

The following aspects can be considered for the various signaling schemes:
For each candidate cell, the NW can provide the candidate cell configuration (within the RRC container), the reference configuration, the L1 measurement configuration, the early TA acquisition configuration, the TCI-state configuration and/or the execution condition (i.e., for UE based triggering mobility).
The execution condition can include the triggering events based on L3 measurements (e.g., for CHO) and/or L1 measurements (e.g., for CLTM).
Flexible association between RRC container and different/multiple triggering mechanism (e.g., UE based triggering, NW based triggering) or mobility type (e.g., LTM, CLTM, CHO, CPA/CPC, subsequent CHO/CPAC/LTM/CLTM). For example, the NW may indicate which mechanism or mobility type is applicable for the RRC container (candidate cell configuration) or the candidate cell, e.g., for UE based triggering, NW based triggering or both.

In some example implementations, in order to avoid the collision between UE based triggering and NW based triggering of mobility (e.g., reception of LTM command upon the execution condition of CLTM is met), several example options may be adopted:
Alt.1: The NW may indicate the priority of the mobility type to execute, e.g., the NW based triggering mobility is prioritized, or the UE based triggering mobility is prioritized.
Alt. 2: The UE notifies the source cell when the execution condition of UE based triggering mobility is met (e.g., sends an UL signaling to inform the source cell).
Alt. 3: It can be up to the UE implementation to execute which type of mobility procedure.

In some example harmonization implementations, CHO/CPAC candidate cell configuration may be provided via condRRCReconfig within conditionalReconfiguration, while LTM candidate cell configuration is provided via ltm-CandidateConfig within LTM-Config. However, the CHO/CPAC candidate cell and LTM/CLTM candidate cell may be the same cell (e.g., with the same frequency+PCI), and the candidate cell configuration provided for CHO/CPAC can be reused for LTM/CLTM, vice versa. In order to avoid providing repeated candidate cell configuration for CHO/CPAC and LTM/CLTM and reduce the signaling overhead, the same candidate cell configuration can be reused for CHO/CPAC and LTM/CLTM.

To reuse the CHO/CPAC configuration for LTM/CLTM, one or more reference indicator can be introduced in the LTM configuration to refer to the CHO/CPAC candidate cell configuration index, e.g., to indicate the corresponding candidate cell configuration or/and execution condition can be used for the LTM/CLTM.

To reuse the LTM/CLTM configuration for CHO/CPAC, one or more reference indicator can be introduced in the conditional configuration to refer to the LTM/CLTM candidate cell configuration index, e.g., to indicate the corresponding candidate cell configuration, L1 measurement configuration, early UL synchronization configuration or/and TCI-state configuration can be used for the CHO/CPAC.

In some example implementations, the following signaling may be adopted:

### LTM-CandidateToAddModList Information Element

--ASN1START
--TAG-LTM-CANDIDATETOADDMODLIST-START
LTM-CandidateToAddModList-r18 ::= SEQUENCE (SIZE (1..maxNrofCellsLTM-r18)) OF
LTM-Candidate-r18

| | |
|---|---|
| LTM-Candidate-r18 ::= | SEQUENCE { |
| ltm-CandidateId-r18 | LTM-CandidateId-r18, |

```
    ltm-CandidateConfig-r18 OCTET STRING (CONTAINING RRCReconfiguration),
  ...,
```

| | |
|---|---|
| Ltm-CandidateReference-r18 | CondReconfigId-r16, OPTIONAL,-- Need M |

...
}
--TAG-LTM-CANDIDATETOADDMODLIST-STOP
--ASN1STOP

### CondReconfigToAddModList Information Element

--ASN1START
--TAG-CONDRECONFIGTOADDMODLIST-START
CondReconfigToAddModList-r16 ::= SEQUENCE (SIZE (1.. maxNrofCondCells-r16)) OF
CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId OPTIONAL, -- Need |

M

| | |
|---|---|
| condRRCReconfig-r16 | OCTET STRING (CONTAINING RRCReconfiguration) |

```
OPTIONAL,-- Cond condReconfigAdd
    ...,
  [[
```

| | |
|---|---|
| condCandidateReference-r18 | LTM-CandidateId-r18, OPTIONAL, -- Need M |

]]
--TAG-CONDRECONFIGTOADDMODLIST-STOP
--ASN1STOP

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a wireless terminal device, comprising:
receiving a conditional layer-1/layer-2 (L1/L2) Triggered Mobility (LTM) configuration from a serving cell of a wireless network, the conditional LTM configuration comprising one or more candidate cell configurations, and an LTM cell switching condition for each of one or more candidate cells;
performing an evaluation of the LTM cell switching condition; and
in response to the LTM cell switching condition being met for a target cell among the one or more candidate cells, initiating a conditional LTM cell switch to the target cell from the serving cell,
wherein the LTM cell switching condition comprises one or more event triggering conditions, the event triggering condition comprises at least one of:
an L1 measurement report configuration identifier for indicating an event-triggered L1 measurement report configuration for the conditional LTM, or
a layer-3 (L3) measurement identifier for indicating an event-triggered L3 measurement configuration.

2. (canceled)

3. The method of claim 12, wherein:
the LTM cell switching condition further comprises an indication for indicating whether a relationship between the one or more event triggering conditions is “AND” or “OR” for triggering the initiation of the conditional LTM cell switch; and/or
the event triggering condition further comprises at least one of:
a layer-1 (L1) measurement identifier for indicating an event-triggered L1 measurement configuration for the conditional LTM;
a threshold or offset value that the event triggering condition needs to meet in order to trigger the initiation of the conditional LTM cell switch;
a time period during which the event triggering condition needs to be met in order to trigger the initiation of the conditional LTM cell switch;
a number of times that the event triggering condition needs to be consecutively met in order to trigger the initiation of the conditional LTM cell switch;
a number of beams or Reference Signals (RSS) for which the event triggering condition needs to be met in order to trigger the initiation of the conditional LTM cell switch;
an indication for indicating whether a combination of the time period and the number of times for which the event triggering condition needs to be met in order to trigger the initiation of the conditional LTM cell switch; or
an indication for indicating whether a relationship between the one or more event triggering conditions is “AND” or “OR” for triggering the initiation of the conditional LTM cell switch.

4. The method of claim 13, further comprising receiving assistance information for the conditional LTM cell switch from the serving cell, the assistance information comprising at least one of:
a first threshold for cell measurement of the serving cell to control when the wireless terminal device is to start the evaluation of the LTM cell switching condition;
a second threshold for cell measurement of a candidate cell or neighboring cell to control when the wireless terminal device is to start the evaluation of the LTM cell switching condition;
a third indication to indicate whether the wireless terminal device can initiate the LTM cell switch upon a Master Cell Group failure or Secondary Cell Group failure; or
a fourth indication to indicate whether the wireless terminal device is to perform the evaluation of the LTM cell switching condition only for a candidate cell for which the wireless terminal device has a valid Timing Advance (TA).

5. (canceled)

6. The method of claim 1, further comprising receiving a conditional LTM evaluation activation or deactivation command from the serving cell, the conditional LTM evaluation activation or deactivation command comprising at least one of:
an indication for indicating whether the conditional LTM evaluation is to be activated or deactivated;
one or more candidate cells to be activated or deactivated;
one or more candidate beams/Reference Signals (RSs) of the one of more candidate cells to be activated or deactivated; or
one or more CSI resource configurations of the one or more candidate cells to be activated or deactivated.

7. (canceled)

8. (canceled)

9. The method of claim 1, wherein initiating the LTM switch to the target cell from the serving cell comprises performing an LTM cell access to the target cell in a Random-Access Channel (RACH)-based manner or a RACH-less manner depending on an availability of a valid Timing Advance (TA) value associated with the target cell.

10. The method of claim 9, further comprising, prior to initiating the conditional LTM cell switch to the target cell, performing a Physical Downlink Control Channel (PDCCH) order triggered early RACH towards the target cell and receiving a TA value of the target cell, wherein the conditional LTM cell switch to the target cell from the serving cell comprises performing the LTM cell access in the RACH-less manner.

11. The method of claim 10, wherein the early RACH is triggered by the wireless terminal device receiving a Downlink Control Information (DCI) from the serving cell, the DCI comprising at least one of:
an indication for indicating whether a reception of TA value by the wireless terminal device is required or not;
an indication for indicating which of the serving cell or target cell the wireless terminal device needs to receive the TA value from;
a time window to monitor/wait to receive the TA value by the wireless terminal device; or
a time value for controlling how long a MAC entity considers an acquired TA value as remaining valid.

12. (canceled)

13. (canceled)

14. (canceled)

15. (canceled)

16. (canceled)

17. The method of claim 9, wherein the LTM cell access is performed in the RACH-less manner, and further comprises accessing the target cell via a configured grant of the LTM.

18. The method of claim 9, wherein the LTM cell access is performed in the RACH-less manner, and further comprises accessing the target cell via a dynamic grant of the LTM (DG LTM) and monitoring a Physical Downlink Control Channel (PDCCH) on the target cell for dynamic scheduling for the DG LTM.

19. (canceled)

20. The method of claim 17, wherein the conditional LTM configuration further comprises a threshold for a Reference Signal (RS) or beam associated with a configured grant or a Transmission Configuration Indication (TCI)-state.

21. The method of claim 20, wherein the threshold comprises a Synchronization Signal Block (SSB)-based L1-RSRP threshold or a Channel State Information Reference Signal (CSI-RS)-based L1-RSRP threshold.

22. The method of claim 21, wherein when the wireless terminal device determines that at least one RS with RSRP corresponding to the configured grant or the TCI-state is above the threshold, further comprising at least one of:
selecting an RS with RSRP above the threshold from among the RS(s) associated with the configured grant;
indicating an index of the selected RS to a lower layer;
considering the configured grant as valid; or
considering the TCI-state as valid, activated or applied.

23. The method of claim 21, wherein when the wireless terminal device determines that no RS with RSRP corresponding to the configured grant or the TCI-state is above the threshold, further comprising at least one of:
considering the configured grant as invalid;
considering the TCI-state as not valid, not activated, or not applied;
monitoring PDCCH on the target cell for dynamic scheduling; or
performing an LTM cell access to the target cell in a RACH-based manner.

24. A method performed by a source access network node in a wireless network, comprising:
transmitting a conditional layer-1/layer-2 (L1/L2) Triggered Mobility (LTM) configuration to a wireless terminal device via a serving cell of the source access network node, the conditional LTM configuration comprising one or more candidate cell configurations, and an LTM cell switching condition for each of one or more candidate cells, to cause the wireless terminal device to perform a conditional LTM cell switch to a target cell from the serving cell when the LTM cell switching condition is met for the target cell among the one or more candidate cells,
wherein the LTM cell switching condition comprises one or more event triggering conditions, the event triggering condition comprises at least one of:
an L1 measurement report configuration identifier for indicating an event-triggered L1 measurement report configuration for the conditional LTM; or
a layer-3 (L3) measurement identifier for indicating an event-triggered L3 measurement configuration.

25. (canceled)

26. The method of claim 245, wherein the event triggering condition comprises at least one of:
a layer-1 (L1) measurement identifier for indicating an event-triggered L1 measurement configuration for the conditional LTM;
a threshold or offset value that the event triggering condition needs to meet be met in order to trigger the initiation of the conditional LTM cell switch;
a time period during which the event triggering condition needs to be met in order to trigger the initiation of the conditional LTM cell switch;
a number of times that the event triggering condition needs to be consecutively met in order to trigger the initiation of the conditional LTM cell switch;
a number of beams or Reference Signals (RSs) for which the event triggering condition needs to be met in order to trigger the initiation of the conditional LTM cell switch; or
an indication for indicating whether a combination of the time period and the number of times for which the event triggering condition needs to be met in order to trigger the initiation of the conditional LTM cell switch; or
an indication for indicating whether a relationship between the one or more event triggering conditions is “AND” or “OR” for triggering the initiation of the conditional LTM cell switch.

27. (canceled)

28. (canceled)

29. The method of claim 24, further comprising transmitting a conditional LTM evaluation activation or deactivation command to the wireless terminal device via the serving cell for the wireless terminal device to activate or deactivate evaluation of the LTM cell switching conditions, the conditional LTM evaluation activation or deactivation command comprising at least one of:
an indication for indicating whether the conditional LTM evaluation is to be activated or deactivated;
one or more candidate cells to be activated or deactivated;
one or more candidate beams/Reference Signals (RSs) of the one of more candidate cells to be activated or deactivated; or
one or more CSI resource configurations of the one or more candidate cells to be activated or deactivated.

30. (canceled)

31. (canceled)

32. A wireless terminal device comprising a processor and a memory, wherein the processor is configured to read code from the memory to implement the method according to claim 1.

33. (canceled)

34. A source access network node apparatus comprising a processor and a memory, the processor being configured to read code from the memory to implement the method according to claim 24.
